(19) United States
(12) Patent Application Publication
(10) Pub. No.: US 2012/0327756 A1
(43) Pub. Date: Dec. 27, 2012

(54) OBJECTIVE LENS, LENS MANUFACTURING METHOD, AND OPTICAL DRIVE DEVICE

(75) Inventor: Koji Sekiguchi, Kanagawa (JP)

(73) Assignee: SONY CORPORATION, Tokyo (JP)

(21) Appl. No.: 13/524,974

(22) Filed: Jun. 15, 2012

(30) Foreign Application Priority Data
Jun. 22, 2011 (JP) 2011-137958

(51) Int. Cl. G11B 7/0045; G02B 3/00; B32B 37/14; G02B 1/10

(52) U.S. Cl. 369/112.25; 359/642; 359/601; 156/60

(57) ABSTRACT

An objective lens includes as a front lens disposed on the most objective side: a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof.

### CROSS REFERENCES TO RELATED APPLICATIONS

The present application claims priority to Japanese Priority Patent Application JP 2011-137958 filed in the Japan Patent Office on Jun. 22, 2011, the entire content of which is hereby incorporated by reference.

### BACKGROUND

The present application relates to an objective lens for condensing incident light and irradiating a target object, a manufacturing method of a lens used for this object lens, and also relates to an optical drive device including the objective lens for performing recording of information as to an optical recording medium, or playing of information recorded in the optical recording medium.

As for optical recording media wherein recording of information and/or playing of recorded information is performed by irradiation of light, so-called optical disc recording media (written simply as “optical disc”), for example, such as CD (Compact Disc), DVD (Digital Versatile Disc), BD (Blu-ray Disc: registered trade mark), and so forth has come into widespread use.

With these optical discs, shortening of wavelength of recording/playing light, and increase in numerical aperture (NA) of an objective lens have gradually been realized, and accordingly, reduction in condensing spot size for recording/playing is realized, and large recording capacity and high recording density have been achieved.

However, with these optical discs according to the related art, the medium between an objective lens and an optical disc is the air, and accordingly, it is widely understood that the numeric aperture NA having influence on the size (diameter) of the condensing spot is not greater than “1”.

Specifically, the size of a light spot to be irradiated on an optical disc via an objective lens is generally obtained by the following, when the numeric aperture of this objective lens is taken as NA_{obj}, and the wavelength of light is taken as λ.

λ/NA_{obj}

At this time, the numeric aperture NA_{obj} is represented with the following expression when the refractive index of a medium between the objective lens and the optical disc is taken as n_{A}, and the incident angle of an ambient light beam of the objective lens is taken as θ.

NA_{obj}=n_{A}×sinθ

As can be understood with reference to this expression, as long as the medium is the air (n_{A}=1), NA_{obj}>1 is not realized.

Therefore, as disclosed in, for example, such as Japanese Unexamined Patent Application Publication No. 2010-33688 and Japanese Unexamined Patent Application Publication No. 2009-134780 and so forth, there has been proposed a recording/playing system (near-field recording/playing system) for realizing NA_{obj}>1 by taking advantage of near-field light (evanescent light).

It is widely understood that, with a near-field recording/playing system, recording/playing of information is arranged to be performed by irradiating near-field light on an optical disc, and at this time, as for an objective lens for irradiating near-field light on the optical disc, a solid immersion lens (Solid Immersion Lens, hereafter abbreviated as SIL) is employed (see Japanese Unexamined Patent Application Publication No. 2010-33688 and Japanese Unexamined Patent Application Publication No. 2009-134780, for example).

FIG. 18 is a diagram for describing an near-field optical system according to the related art using an SIL. Note that this FIG. 18 illustrates an example employing a super-semispherical SIL (super-semisphere SIL) as an SIL. Specifically, with the super-semisphere SIL in this case, the shape of an objective side (i.e., side where a recording medium to be recorded/played is disposed) is taken as a planar shape, and portions other than this are taken as a super-semisphere shape.

An objective lens in this case is configured as a 2-group lens having the above super-semisphere SIL as the front lens. As illustrated in FIG. 18, a double-sided aspherical lens is employed as the rear lens.

Now, the effective numeric aperture NA of the objective lens according to the configuration illustrated in FIG. 18 is represented as follows when the incident angle of incident light is taken as Ai, and the refractive index of a component material of the super-semisphere SIL is taken as n_{SIL}.

NA=n_{SIL}²×sinθi

From this expression, according to the configuration of the objective lens illustrated in FIG. 18, it can be found that the effective numeric aperture NA can be set greater than “1” by setting the refractive index n_{SIL} of the SIL greater than “1” (higher than the refractive index of the air).

Heretofore, as for the refractive index of an SIL, for example, around n_{SIL}=2 is set, and accordingly, 1.8 or so is realized as an effective numeric aperture NA.

Now, as for a near-field optical system, not only a configuration employing a super-semisphere SIL as described above but also a configuration employing a super-semispherical SIL (semisphere SIL) may be employed.

In the event of employing an objective lens employing a semispherical SIL instead of the super-semisphere SIL illustrated in FIG. 18, an effective numeric aperture NA thereof is as follows.

NA=n_{SIL}×sinθi

According to this expression, in the event of employing a semisphere SIL as well, a high refractive index material of n_{SIL}>1 is employed as a component material of an SIL, and accordingly, it is found that NA>1 can be realized.

At this time, when comparing with the expression in the case of the previous super-semisphere SIL, in the event that the component materials (refractive index) of the SILs in the case of a super-semispherical shape and in the case of a semispherical shape are the same, it can be found that an effective NA can be set higher in the case of employing a super-semisphere SIL.

Note that, in order to perform recording/playing by propagating (irradiating) light (near-field light) of NA>1 generated by an SIL on a recording medium, the objective surface of the SIL, and the recording medium have to be disposed very closely. An interval between the objective surface of the SIL, and the recording medium (recording surface) at this time is referred to as a gap. With a near-field recording/playing system, it is expected that the value of the gap is suppressed equal to or smaller than at least a quarter of the wavelength of light.

As described above, an objective lens including an SIL made up of a semispherical or super-semispherical shape is employed, whereby the numeric aperture NA can be set greater than “1”, and consequently, the spot diameter can be reduced beyond the limitation in an optical disc system according to the related art. That is to say, improvement in recording density, and consequently, large recording capacity is realized by an equivalent amount.

Now, it can be said that, with regard to high recording density and large recording capacity, a level thereof can do no better than great, and further improvement is anticipated. In terms of realizing large recording capacity by reducing the spot size of recording light, it is effective to employ a plasmon antenna system using a metal pin such as disclosed in Japanese Unexamined Patent Application Publication No. 2005-116155.

Specifically, with the disclosure according to Japanese Unexamined Patent Application Publication No. 2005-116155, light is input to the metal pin (metal nanostructure) in a state vertically inverted as to a recording medium, and accordingly, the minimum light spot is generated by surface plasmon effect (local near-field effect), and recording is performed by this.

According to such a plasmon antenna system according to Japanese Unexamined Patent Application Publication No. 2005-116155, larger reduction of a recording spot can be realized by a generating principle of near-field light thereof as compared to the case of employing a near-field system using an SIL. Also, increase in recording power (light intensity) can also be realized by operation of plasmon resonance (resonance).

### SUMMARY

However, with the plasmon antenna system according to Japanese Unexamined Patent Application Publication No. 2005-116155, irradiation of near-field light is performed by the metal pin, and accordingly, recording is enabled, but playing is disabled. That is to say, the plasmon antenna system does not have reversibility of light in that playing with the above metal pin is disabled, and accordingly, a point that the optical system is not shared at the time of recording and at the time of playing causes a problem.

It has been found to be desirable to realize further high recording density and large recording capacity by improving an effective NA as compared to a case of an objective lens employing an SIL according to the related art while securing light reversibility for sharing an optical system at the time of recording and at the time of playing.

According to an embodiment, an objective lens of the present application includes, as a front lens disposed on the most objective side, a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof.

Also, with the present application, the following first and second methods will be proposed as a lens manufacturing method according to an embodiment.

According to an embodiment, a first lens manufacturing method is a lens manufacturing method for manufacturing a lens configured to have a laminated structure where a first thin film of which the permittivity is negative, and a second thin film of which the permittivity is positive are mutually laminated, and also the films are formed so as to have a rectangular shape protruding on a side to which light from a light source is input, as a cross-sectional shape thereof, including: a protruding portion forming process arranged to form a protruding portion where the cross-sectional shape of a tip portion thereof is a rectangular shape as to a substrate; and a laminating process arranged to mutually laminate the first thin film and the second thin film as to the protruding portion formed in the protruding portion forming process.

Also, a second lens manufacturing method according to an embodiment is as follows.

According to an embodiment, the second lens manufacturing method is a lens manufacturing method for manufacturing a lens configured to have a laminated structure where a first thin film of which the permittivity is negative, and a second thin film of which the permittivity is positive are mutually laminated, and also the films are formed so as to have a rectangular shape protruding on a side to which light from a light source is input, as a cross-sectional shape thereof, including: a recessed portion forming process arranged to form a recessed portion where the cross-sectional shape of a tip portion thereof is a rectangular shape as to a substrate; and a laminating process arranged to mutually laminate the first thin film and the second thin film as to the recessed portion formed in the recessed portion forming process.

Also, with the present application, an optical drive device according to an embodiment is configured as follows.

According to an embodiment, the optical drive device of the present application includes: an objective lens including as a front lens disposed in a position closest to an optical recording medium, a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof; and a recording/playing unit configured to perform recording of information as to the optical recording medium or playing of recorded information of the optical recording medium by performing light irradiation as to the optical recording medium via the objective lens.

Now, with the laminated structure where the thin film of which the permittivity is negative, and the thin film of which the permittivity is positive are mutually laminated as described above, light of NA>1 (NA: Numeric Aperture) can be propagated. Also, with this laminated structure, the films are formed so as to have a rectangular shape protruding on an incident side as a cross-sectional shape thereof, whereby near-field light with high NA according to local near-field effect (surface plasmon effect) can be generated at a rectangular tip portion on the incident side thereof, as described above. Note that “near-field light with high NA” mentioned here indicates the minimum light spot caused due to surface plasmon effect, having resolution determined by the dimensions of a microstructure portion.

Thus, according to the objective lens of the present application, the near-field light caused due to surface plasmon effect at the tip portion of the laminated structure can be propagated within this laminated structure and irradiated on a target object.

The present application is a technique taking advantage of surface plasmon effect in the same way as with the plasmon antenna system, whereby the spot size can be reduced as compared to the case of the near-field system employing an SIL (Solid Immersion Lens) according to the related art. On the other hand, the present application is not a technique employing a metal pin such as the plasmon antenna system, whereby light reversibility can be realized such as a near-field system according to the related art.

According to the above configurations, further high recording density and large recording capacity can be realized by improving a more effective NA than the case of an objective lens employing a SIL according to the related art while securing light reversibility for sharing an optical system at the time of recording and at the time of playing. Also, an objective lens providing excellent advantages can be manufactured. Also, recording/playing employing the objective lens can be performed.

Additional features and advantages are described herein, and will be apparent from the following Detailed Description and the figures.

### BRIEF DESCRIPTION OF THE FIGURES

FIG. 1 is an explanatory diagram regarding an objective lens serving as a preceding example;

FIG. 2 is an enlarged cross-sectional view of a hyper lens portion included in the objective lens of the preceding example;

FIG. 3 is a diagram illustrating the configuration of an objective lens with a hyper lens being separately provided;

FIG. 4 is a diagram indicating specific calculation results for demonstrating an advantage that the objective lens of the preceding example provides;

FIGS. 5A and 5B are explanatory diagrams regarding the configuration of an objective lens according to an embodiment;

FIGS. 6A and 6B are diagrams for describing operation of a hyper lens portion according to an embodiment;

FIGS. 7A and 7B are diagrams illustrating a result of performing simulation of the intensity of light which propagates within a lens regarding the hyper lens portion according to an embodiment and a hyper lens portion according to a preceding example;

FIG. 8 is a diagram comparing a modulation level in the case of employing the hyper lens portion according to an embodiment, and a modulation level in the case of employing the hyper lens portion according to the preceding example;

FIGS. 9A through 9C are explanatory diagrams regarding a spot size and intensity changing depending on the angle of a tip portion of the hyper lens portion;

FIG. 10 is an explanatory diagram regarding stray light due to reflection/scattering caused on the hyper lens portion;

FIGS. 11A and 11B are explanatory diagrams regarding a mask layer (and a protection layer);

FIG. 12 is a diagram for describing a first manufacturing method of lens manufacturing methods according to embodiments;

FIG. 13 is a diagram for describing a second manufacturing method of the lens manufacturing methods according to the embodiments;

FIG. 14 is a diagram principally illustrating the internal configuration of an optical pickup of an optical drive device according to an embodiment;

FIG. 15 is a diagram illustrating the cross-sectional configuration of an optical recording medium to be recorded/played with an embodiment;

FIG. 16 is a diagram illustrating the entire internal configuration of the optical drive device according to an embodiment;

FIG. 17 is a diagram for describing a relation between a gap length and return light amount from an objective lens; and

FIG. 18 is a diagram for describing a near-field optical system employing a solid immersion lens.

### DETAILED DESCRIPTION

Hereafter, embodiments according to the present application will be described. Note that description will be made in accordance with the following sequence.
1. Objective Lens Serving as Preceding Example
2. Problems Included in Preceding Examples
3. Objective Lens Serving as Embodiment
3-1. Configuration and Advantage of Objective Lens
3-2. First Manufacturing Method
3-3. Second Manufacturing Method
3-4. Configuration of Optical Pickup
3-5. Internal Configuration of Entire Drive Device
4. Modifications

### 1. Objective Lens Serving as Preceding Example

First, description will be made regarding an objective lens OL′ as a preceding example serving as a comparison object of an objective lens according to the present embodiment.

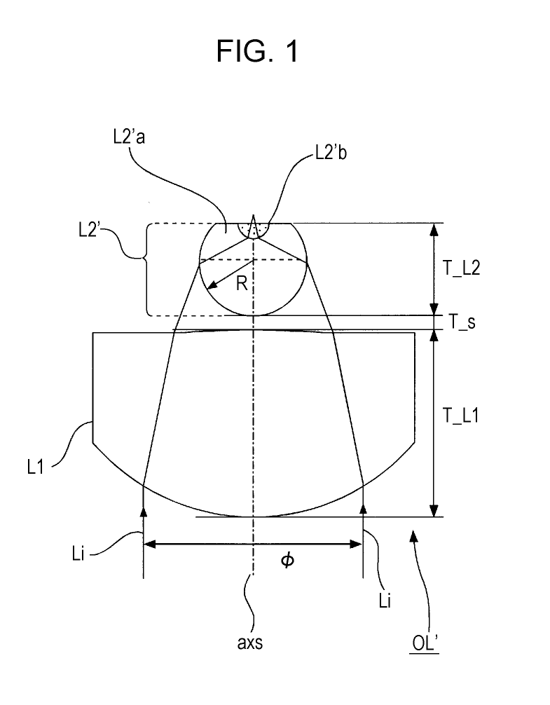

FIG. 1 is a diagram for describing the configuration of the objective lens OL′ serving as a preceding example. Note that FIG. 1 illustrates the cross-section of the objective lens OL′. Also, FIG. 1 illustrates incident light Li as to the objective lens OL′ and an optical axis axs thereof together.

As illustrated in FIG. 1, the objective lens OL′ serving as a preceding example is taken as a 2-group lens having a rear lens L1 and a front lens L2′. In this case, a double-sided aspherical lens is employed as the rear lens L1. The rear lens L1 inputs convergence light based on the incident light Li to the front lens L2′.

The front lens L2′ is a lens wherein a hyper lens portion L2′b is formed integral with an SIL portion (SIL: Solid Immersion Lens) L2′a. In other words, it can also be said that the front lens L2′ is a lens wherein the hyper lens portion L2′b is formed as to a portion of the solid immersion lens.

The SIL employed as the front lens L2′ (SIL portion L2′a) is taken as an SIL having a super-semispherical shape as shown in FIG. 1. Specifically, the SIL portion L2′a in this case is taken as a super-semispherical SIL with an objective side thereof being a plane.

Note that “objective side” means a side where an object to be subjected to light irradiation according to the objective lens is disposed. An objective lens OL′ according to the present preceding example is applied to a recording/playing system as to an optical recording medium, and accordingly, when mentioning the objective side, this means a side where an optical recording medium is disposed.

The SIL portion L2′a serving as a solid immersion lens is configured of at least a high-refractive index material of which the refractive index is greater than 1, and generates near-field light (evanescent light) due to numeric aperture NA>1 based on the incident light from the rear lens L1.

With the front lens L2′, the hyper lens portion L2′b is formed in a portion facing the objective surface of the SIL portion L2′a as illustrated in FIG. 1. According to such a configuration, the light due to NA>1 generated by the SIL portion L2′a is input to the hyper lens portion L2′b. As illustrated in FIG. 1, the hyper lens portion L2′b has a generally semispherical shape as an entire shape thereof.

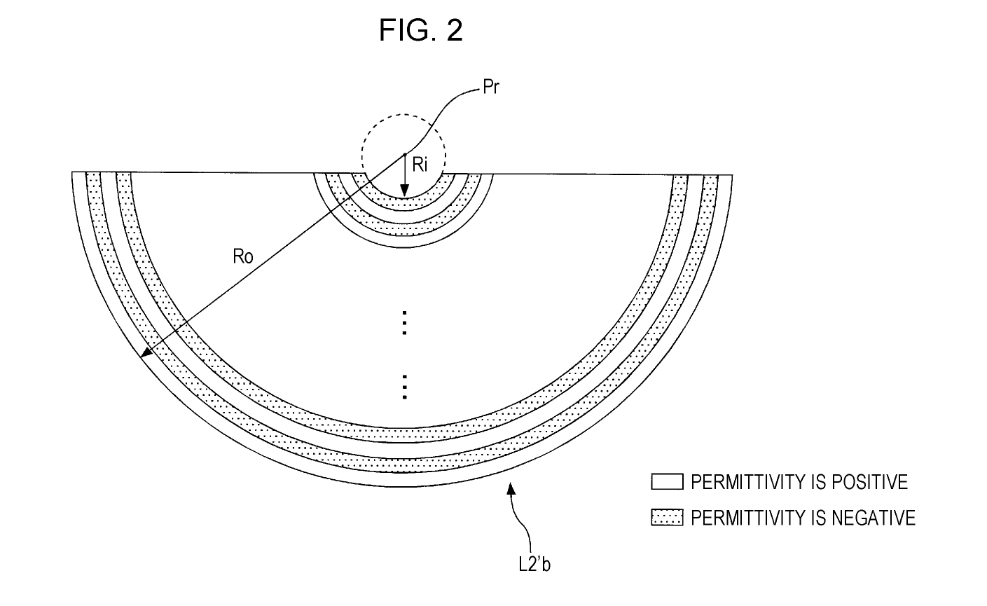

FIG. 2 is an enlarged cross-sectional view of the hyper lens portion L2′b. As illustrated in FIG. 2, the hyper lens portion L2′b has a configuration where multiple thin films are laminated. Specifically, the hyper lens portion L2′b is formed by a first thin film of which the permittivity ε is negative (ε<0), and a second thin film of which the permittivity ε is positive (ε>0) being mutually laminated.

Here, a material of which the permittivity ε is negative is also referred to as a plasmonic material (Plasmonic Material). Examples of a plasmonic material include Ag, Cu, Au, and Al. Also, examples of a material of which the permittivity ε is positive include silicon system compounds such as SiO₂, SiN, SiC, and so forth, fluoride such as MgF₂, CaF₂, and so forth, nitride such as GaN, AIN, and so forth, metal oxide (Metal Oxide), glass, and polymer.

Here, the permittivity ε varies according to wavelength λ of light to be used. Accordingly, the materials of the first thin film and second thin film have to be selected according to the wavelength λ. so as to obtain a desired permittivity ε.

In the case of the present preceding example, Ag is selected as the material of the first thin film, and Al₂O₃ is selected as the material of the second thin film (in the case of the present preceding example, wavelength λ=405 nm or so is assumed).

In FIG. 2, laminating of the first thin film and second thin film is performed along a spherical surface according to a radius Ri with a predetermined reference point Pr that is set outside of the objective side of the hyper lens portion L2′b (i.e., the same as the outside on the objective side of the front lens L2′) as the center up to a spherical surface according to a radius Ro (Ro>Ri) with the reference point Pr as the center. At this time, laminating of the first thin film and second thin film is performed with the spherical surface as a reference, and accordingly, laminating of the thin films is performed in a dome shape as illustrated in FIG. 2. Consequently, the cross-sectional shape of the hyper lens portion L2′b becomes a shape such as annual rings (semiannual ring shape) as illustrated in FIG. 2.

Note that the hyper lens portion L2′b has a generally semicircular shape as the entire shape thereof as described above, and accordingly, the surface shape on the objective side thereof is a planar shape except for a portion having a spherical shape according to the radius Ri. The reason why the surface on the objective side of the hyper lens portion L2′b is formed in a generally planar shape in this way is to handle that the surface shape on the objective side of the SIL portion L2′a formed integral with this hyper lens portion L2′b has a planar shape.

Here, a total number of layers of the first thin film and second thin film being laminated is preferably 3 through 100000. Specifically, 68 layers or so are used in the case of the present preceding example. Also, the film thickness of each thin film is preferably 4 nm through 40 nm, and in the case of the present preceding example, the first and second thin films are both set to 10 nm.

The hyper lens portion L2′b has a configuration where the first thin film of which the permittivity is negative, and the second thin film of which the permittivity is positive are mutually laminated, as described above. According to such a configuration, with the hyper lens portion L2′b, light of NA>1 (near-field light) can be propagated in a direction parallel to the laminating direction of the thin films. That is to say, thus, light of NA>1 generated by the SIL portion L2′a can be propagated and emitted to the objective side.

Also, according to the laminated structure of the hyper lens portion L2′b described above, at the time of emitting light input from the spherical surface side of the radius Ro, from the spherical surface side of the radius Ri, the light flux of the light (i.e., the spot diameter of the light) can be reduced by an amount equivalent to a ratio between the radius Ri and radius Ro (Ro/Ri).

According to such operation, the minimum light spot that is realized by light of NA>1generated by the SIL portion L2′a can further be reduced depending on the hyper lens portion L2′b, and also, this can be propagated and irradiated on the optical recording medium.

As a result thereof, according to the objective lens OL′ serving as the preceding example, there can be realized recording with a smaller spot diameter than the case of an objective lens employing a solid immersion lens according to the related art. That is to say, even-higher recording density and even-larger recording capacity can be realized accordingly.

Also, according to the hyper lens portion L2′b having the configuration illustrated in FIG. 2, with regard to the return light from the objective side, light flux thereof can be enlarged by an amount equivalent to a ratio between the radius Ri and the radius Ro. That is to say, the hyper lens portion L2′b can reversely reduce/enlarge the light flux.

According to the objective lens OL′ having the hyper lens portion L2′b which can perform such reversely reduction/enlargement, with regard to a mark (information) recorded by the minimum spot using the current objective lens OL′, readout thereof can also be performed.

That is to say, as a result thereof, in the same way as a case of an optical disc system according to the related art such as CD (Compact Disc), DVD (Digital Versatile Disc), BD (Blu-ray Disc: registered trademark) or the like, recording/playing employing a common optical system can be realized. In other words, there can be omitted a complicated configuration such as employing different optical systems at the time of recording and at the time of playing.

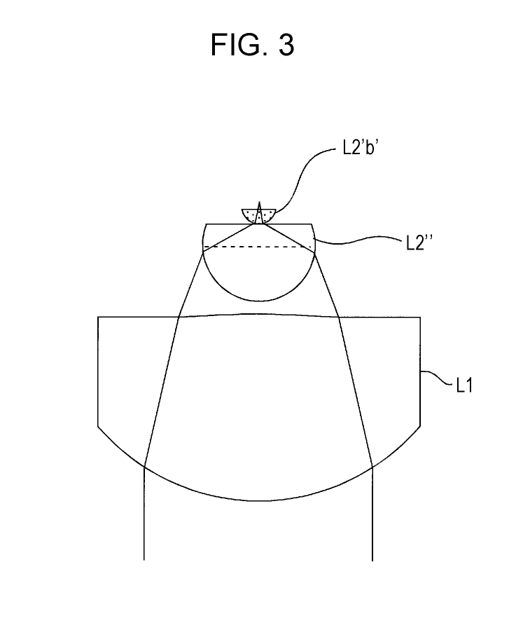

Incidentally, with the preceding example, though the hyper lens portion L2′b is formed integral with the SIL portion L2′a, it can be conceived that, with a view wherein further reduction operation of the spot diameter, and light reversibility are obtained according to the hyper lens portion L2′b as described above, for example, as illustrated in FIG. 3, a front lens L2″ taken as the same SIL as an SIL according to the related art, a hyper lens portion L2′b′ having the same configuration as the hyper lens portion L2′b are separately configured.

However, in the event that the front lens L2″ serving as an SIL, and the hyper lens portion L2′b′ have been separately provided in this way, a medium at a region other than a point where the front lens L2″ is in contact with the hyper lens portion L2′b′ is the air, and accordingly, light reflection loss is caused at the time of input of light from the front lens L2″ to the hyper lens portion L2′b′. At this time, the front lens L2″ serving as an SIL, and the hyper lens portion L2′b′ are both configured of a high-refractive index material, and accordingly, such loss due to reflection is extremely great.

According to the hyper lens portion L2′b being formed integral with the SIL as illustrated in FIG. 1, occurrence of such a problem can effectively be avoided, and using efficiency of light can dramatically be enhanced.

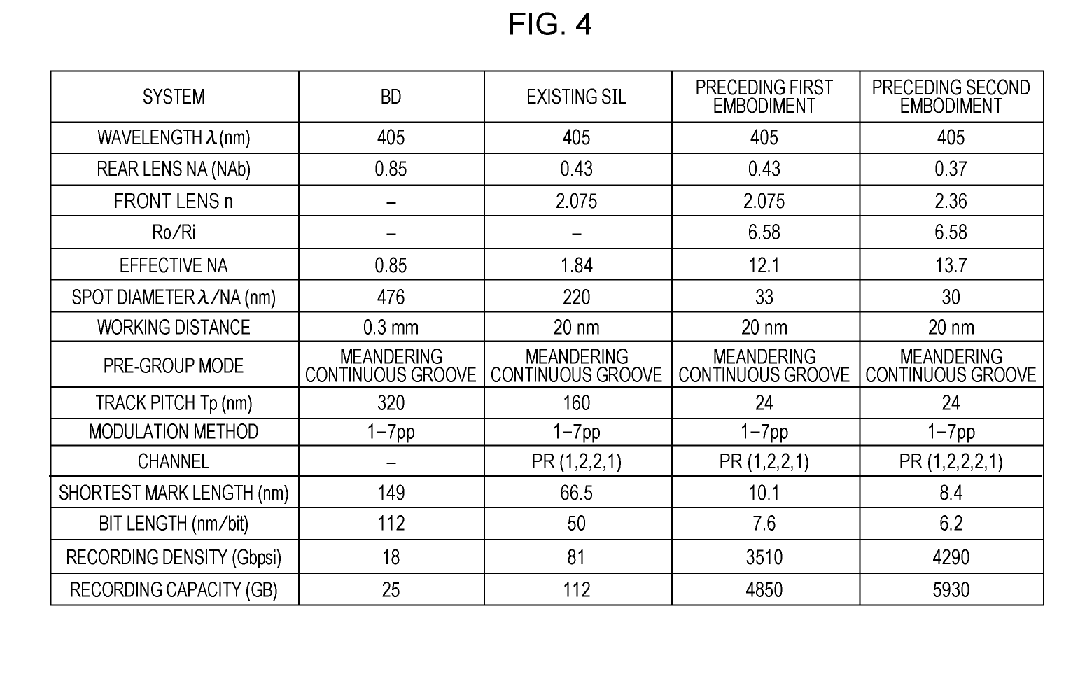

FIG. 4 indicates specific calculation results for demonstrating an advantage that the objective lens OL′ of the preceding example provides according to the above description. This FIG. 4 illustrates each of the conditions of wavelength λ(nm), rear lens NA (NAb), front lens refractive index (n), reduction/enlargement ratio (Ro/Ri), effective NA, λ/NA (nm), working distance (distance with a recording medium: gap), pre-group form, track pitch Tp (nm), modulation method, and channel, and illustrates calculation results regarding shortest mark length (nm), bit length (nm/bit), recording density (Gbpsi), and recording capacity (GB) for each system employing the objective lens OL′ of a BD system, SIL system according to the related art, and preceding examples (preceding first embodiment, preceding second embodiment in FIG. 4).

Note that, in FIG. 4, a system of “ SIL according to the related art” indicates a system employing a super-semispherical solid immersion lens illustrated in the previous FIG. 18. Also, in FIG. 4, “channel” represents a classification of a PR (Partial Response) to be employed. Also, “recording capacity” indicates recording capacity in the case of 12-cm disc.

Here, as for the system of the preceding example, difference between the preceding first embodiment and the preceding second embodiment is principally difference with the NA of a rear lens L1, and difference with the refractive index n of the front lens L2′.

Note that, as for a condition other than indicated in FIG. 4, with the system according to the preceding first embodiment, thickness (length of a direction parallel to the optical axis axs) T_L1 of the rear lens L1, thickness T_L2 of the SIL portion L2′a, a radius R of the SIL portion L2′a, and space (distance from a peak point of the objective side surface of the rear lens L1 to a peak point of the super-semispherical surface of the SIL portion L2′a) T_s between the rear lens L1 and the front lens L2′ indicated in FIG. 1 are set as follows.

T_{—L}1=1.7 mm

T_L2=0.7124 mm

R=0.45 mm

T_s=0.1556 mm

Also, incident light Li to the rear lens L1 is taken as parallel light, and a diameter Φ thereof is taken as 2.1 mm.

In FIG. 4, first, the wavelength λ is taken as λ=405 nm that is common to the cases of a BD, an SIL according to the related art, and preceding first and second embodiments.

Also, the rear lens NA is the NA of an objective lens in the case of the BD, and is 0.85. Also, the rear lens NA is commonly the NA of a rear lens L1 in the cases of the SIL according to the related art, preceding first embodiment, and preceding second embodiment, and are the same value 0.43 in the case of the SIL according to the related art and preceding first embodiment, and also 0.37 in the case of the preceding second embodiment.

Also, with regard to a refractive index n of the front lens, the n is not applicable in the case of the BD, and the n is commonly 2.075 in the cases of the SIL according to the related art and preceding first embodiment. Also, the n is 2.36 in the case of the preceding second embodiment.

With regard to a reduction/enlargement ratio (Ro/Ri), the preceding first and second embodiments are applicable, and are both 6.58 as shown in FIG. 4. Note that, in the case of the present example, it is assumed to set the radius Ri to 120 nm, and the radius Ro to 790 nm, and a result thereof Ro/Ri is 6.58.

The effective NA is effective numeric aperture NA of the objective lens, and is 0.85 in the case of the BD, and 1.84 in the case of the SIL according to the related art. On the other hand, the effective NA is 12.1 in the case of the preceding first embodiment, and 13.7 in the case of the preceding second embodiment.

Note that the effective NA of the objective lens in the case of the SIL according to the related art (super-semispherical SIL) is, as previously indicated, obtained as follows.

NA=n_{SIL}²×sinθi

On the other hand, the effective NA of the objective lens OL′ in the cases of the preceding first and second embodiments is calculated as follows.

NA=n²×NAb×(Ro/Ri)

The spot diameter is 476 nm in the case of the BD, and 220 nm in the case of the SIL according to the related art. On the other hand, the spot diameter is 33 nm in the case of the preceding first embodiment, and 30 nm in the case of the preceding second embodiment.

According to the objective lens OL′ serving as the preceding examples in this way, significant reduction in the spot diameter can be realized as compared to the case of the SIL according to the related art.

Also, the working distance is 0.3 mm in the case of the BD. Also, in the case of the near-field recording/playing system serving as the SIL according to the related art and preceding first and second embodiments, the working distance (i.e., gap G) is 20 nm. Also, the pre-groove form is a meandering continuous groove (wobbling groove) common to the cases. A track pitch Tp is 320 nm in the case of the BD, and 160 nm in the case of the SIL according to the related art.

In the cases of the preceding first and second embodiments, reduction in the spot diameter is realized as described above, and accordingly, the track pitch Tp becomes 24 nm narrower than the case of the SIL according to the related art.

The modulation method is a 1-7 pp modulation method common to the cases. Also, the channel is not applicable in the case of the BD (without PRML decoding), and also in the case of the SIL according to the related art and preceding first embodiment, PR(1, 2, 2, 1) is commonly employed. Also, in the case of the preceding second embodiment, PR(1, 2, 2, 2, 1) is employed.

The shortest mark length is 149 nm in the case of the BD, and 66.5 nm in the case of the SIL according to the related art. On the other hand, the shortest mark length in the case of the preceding first embodiment can be reduced up to 10.1 nm, and the shortest mark length in the case of the preceding second embodiment can be reduced up to 8.4 nm.

The bit length is 112 nm/bit in the case of the BD, and 50 nm/bit in the case of the SIL according to the related art. On the other hand, the bit length is 7.6 nm/bit in the case of the preceding first embodiment, and 6.2 nm/bit in the case of the preceding second embodiment, which are significantly reduced as compared to the case of the SIL according to the related art.

The recording density is 18 Gbpsi in the case of the BD, and 81 Gbpsi in the case of the SIL according to the related art. On the other hand, the recording density is 3510 Gbpsi in the case of the preceding first embodiment, and 4290 Gbpsi in the case of the preceding second embodiment.

As a result thereof, according to the objective lens OL′ serving as the preceding examples, it can be found that the recording density can be improved several tens of times as compared to the case of the SIL according to the related art.

Also, the recording capacity is 25 GB in the case of the BD, and 112 GB in the case of the SIL according to the related art. On the other hand, in the cases of the preceding first and second embodiments, the recording capacity increases up to 4850 GB and 5930 GB, respectively.

As can be understood from this result, according to the objective lens OL′ serving as the preceding examples, the recording capacity can also be improved several tens of times or so as compared to the case of the SIL according to the related art.

### 2. Problems Included in Preceding Examples

According to the objective lens OL′ serving as the preceding examples as described above, high recording density and large recording capacity can be realized by reducing the spot diameter as compared to the case of employing the near-field system using the SIL according to the related art while securing light reversibility.

However, with regard to the hyper lens portion L2′b employed for the preceding examples, it is difficult to enhance the light intensity of a spot, for example, as compared to the case of employing the plasmon antenna system disclosed in Japanese Unexamined Patent Application Publication No. 2005-116155.

Specifically, a metal film (first thin film) used for the hyper lens portion L2′b also functions as a reflecting film, and accordingly, the attenuation amount of light is relatively great. Here, with the hyper lens portion L2′b, the spot size is determined with a ratio (Ro/Ri) of an outer diameter/an inner diameter thereof, and accordingly, in the event of reducing the spot size, the thickness tends to increase accordingly. That is to say, the number of laminated thin films tends to increase. Specifically, when attempting to realize a spot size (Ro/Ri=6.5 or so) of 30 nm or so as described above, the number of laminated thin films of the hyper lens portion L2′b becomes 60 layers or so at the time of taking the film thickness (=10 nm or so) of each of the above thin films, and so forth into consideration. Of the number of laminated thin films, the number of laminated first thin films made up of a metal film is generally 30 layers or so of a half thereof

In the event that the intensity of a light spot is small, this leads to lack of recording power, and deterioration in an SNR (S/N ratio) at the time of playing, and results in deterioration in recording performance/playing performance.

### 3. Objective Lens Serving as Embodiment

### 3-1. Configuration and Advantage of Objective Lens

Therefore, with the present embodiment, there will be proposed an objective lens whereby improvement in light spot intensity can be realized while securing light reversibility such as the hyper lens portion L2′b of the preceding examples (hereafter, also referred to as spherical-surface hyper lens), and also realizing more reduction in the spot diameter as compared to the near-field system employing an SIL according to the related art.

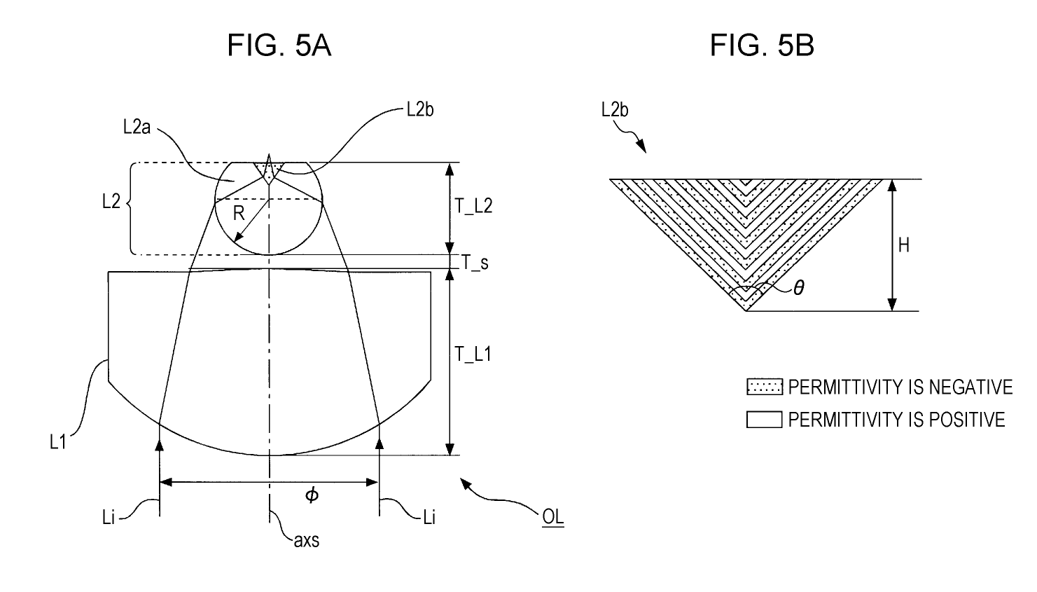

FIGS. 5A and 5B are explanatory diagrams regarding the configuration of an objective lens (let us say this as objective lens OL) serving as an embodiment of the objective lens of the present application.

FIG. 5A illustrates a cross-sectional view of the entire objective lens OL, and FIG. 5B illustrates an enlarged cross-sectional view of the hyper lens portion L2b included in the objective lens OL, respectively. Note that, in FIGS. 5A and 5B, with regard to portions as same as portions already described in the preceding examples, the same reference numerals are denoted, and description thereof will be omitted.

With the objective lens OL according to the present embodiment, the hyper lens portion L2b made up of a laminated structure having a rectangular shape protruding on a side where incident light Li is input for a light source (i.e., alternately laminated member of the first thin film and second thin film) as illustrated in FIG. 5A is formed instead of the hyper lens portion L2′b made up of a spherical surface.

Note that, as can be understood with reference to FIG. 5A, with the present example as well, the hyper lens portion L2b is formed integral with a portion facing the objective surface in an SIL (taken here as SIL portion 2a).

Specifically, the hyper lens portion L2b according to the present example is formed by alternately laminating each of the first thin film and second thin film in a V-letter shape at a cross-section thereof as illustrated in FIG. 5B. Also, the surface shape of the objective side is formed with a planar surface in response to the objective surface of the SIL portion L2a being formed with a planar surface in the same way as with the cases of the preceding example. Thus, with the hyper lens portion L2b, the entire cross-sectional shape thereof is a generally triangular shape.

Note that the outer shape of the hyper lens portion L2b in this case may be a pyramid shape (square pyramid shape) or may be a conical shape.

Here, in this case as well, the first thin film has a permittivity ε<0, and the second thin film has a permittivity ε>0. With the present example as well, the materials of these first thin film and second thin film may be selected according to the wavelength 80 to be used so as to obtain a desired permittivity ε.

Specific materials may be the same as those described in the preceding examples.

In the case of the present example, let us say that Ag as the material of the first thin film, and Al₂O₃ as the material of the second thin film have been selected, respectively.

Now, let us say that the laminating sequence of these thin films is a sequence of the first thin film to the second thin film in order from the incident side of light from a light source. Also, the film thicknesses of the first and second thin films has suitably to be set within a range of 4 nm through 40 nm or so in the same way as with the case of the preceding examples.

Note that, as illustrated in FIG. 5B, let us say that distance from the surface on the objective side of the hyper lens portion L2b to the peak of the edge portion (corner) on the incident side (thickness of the hyper lens portion L2b) is taken as H.

Also, the angle of the corner (tip portion) on the incident side of the hyper lens portion L2b will be represented as θ.

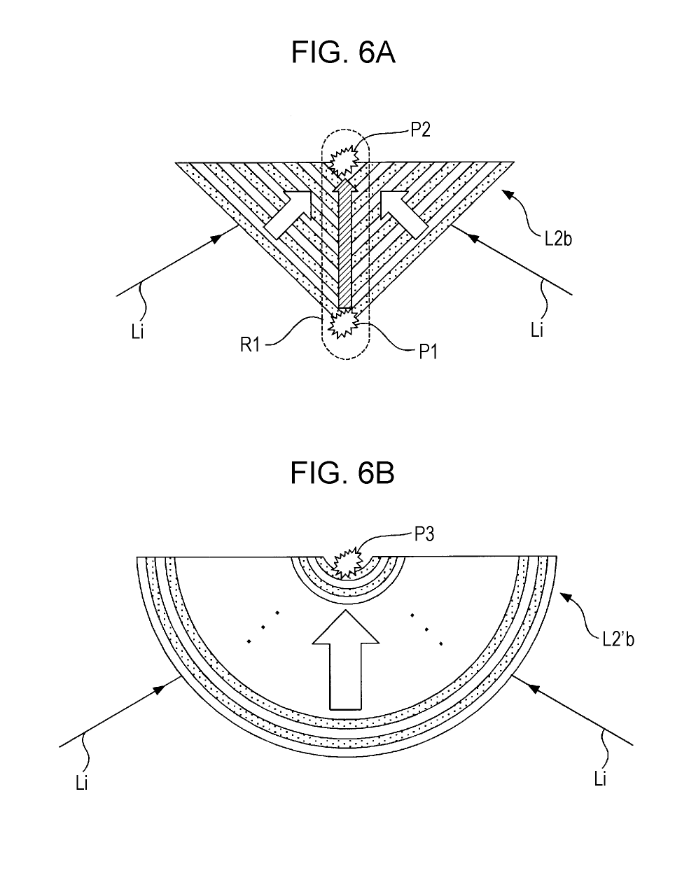

FIGS. 6A and 6B are diagrams for describing the operation of the hyper lens portion L2b according to an embodiment. FIG. 6A schematically illustrates operation obtained at the hyper lens portion L2b, and FIG. 6B schematically illustrates operation obtained at the hyper lens portion L2′b of the preceding example to be compared. Note that incident light Li in FIGS. 6A and 6B means incident light from the SIL portion L2a (L2′a in the case of FIG. 6B).

In FIG. 6A, with the hyper lens portion L2b according to an embodiment, the tip portion on the incident side has a rectangular shape. Thus, with the tip portion on this incident side, near-field light (local near-field light) accompanying local near-field effect (surface plasmon effect) is generated as illustrated in P1 in FIG. 6A.

It is widely understood that local near-field effect is generated by electrons within metal causing interaction with light. In particular, like the hyper lens portion L2b according to the present example, in the case of a configuration wherein rectangular thin films are cyclically arrayed in the inner side thereof following the rectangular tip portion, resonance between electrons and light (plasmon resonance) is facilitated, extremely high light output can be provided.

With the hyper lens portion L2b, the first thin film and the second thin film are alternately laminated, and accordingly, the near-field light thus generated propagates within this hyper lens portion L2b (diagonal arrow in FIG. 6A). The near-field light thus propagated is output from the objective surface as illustrated in P2 in FIG. 6A.

In FIG. 6A, a region near the center axis of the hyper lens portion L2b according to generation/propagation/output of such local near-field light is indicated as a region R1. Also, in the event that the hyper lens portion L2b is configured of a triangular cross-sectional shape, a laminated region of the first and second thin films that can propagate near-field light is obtained other than the region R1 according to the generation, propagation and so forth of local near-field light.

Thus, according to the hyper lens portion L2b, an operation can also simultaneously be obtained wherein a component of NA>1 generated by the SIL portion L2a is propagated and output (white arrow in FIG. 6A).

On the other hand, in the case of the hyper lens portion L2′b according to the preceding example, as illustrated in FIG. 6B, of two operations obtained by the hyper lens portion L2b according to these embodiments, the latter operation, i.e., only an operation is obtained wherein an incident light component of NA>1 generated by the SIL portion is propagated and output.

Here, light intensity according to local near-field light is extremely great. Also, the case of the present example has a multilayer configuration, and accordingly, metal films are cyclically disposed, plasmon resonance effect can also be obtained within the multilayer configuration.

Accordingly, as is apparent from the above comparison, according to the hyper lens portion L2b according to the present embodiment, the light intensity of a spot can dramatically be improved as compared to the hyper lens portion L2′b according to the preceding example.

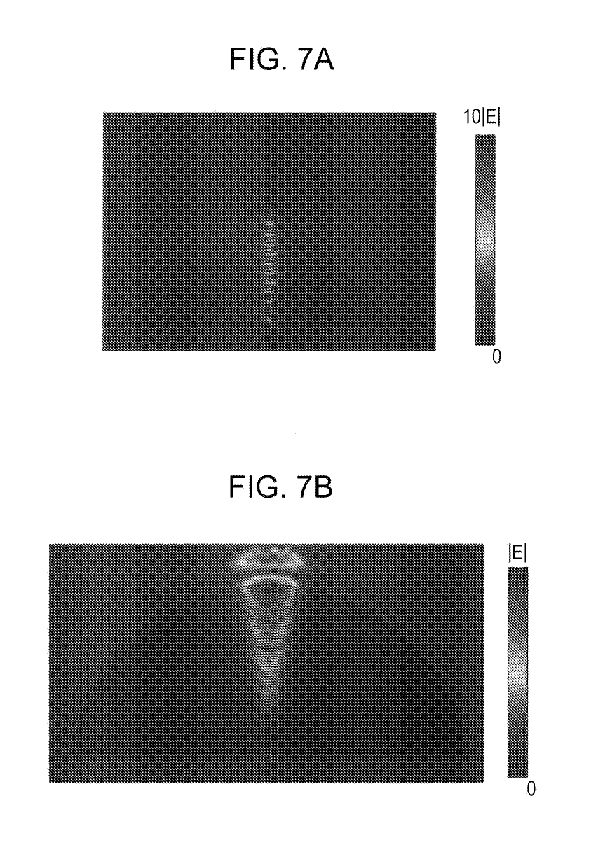

FIGS. 7A and 7B illustrate a result of having performed a simulation of the intensity of light that propagates within the lenses of the hyper lens portion L2b according to an embodiment (FIG. 7A) and the hyper lens portion L2′b according to the preceding example (FIG. 7B), respectively.

Note that, at the time of obtaining a simulation result illustrated in FIGS. 7A and 7B, the film thicknesses and number of laminated layers of the first and second thin films were set so as to have the same size of a light spot to be formed. Specifically, under a condition of each film thickness=10 nm, the number of laminated layers is set to 12 or so in the case of FIG. 7A, and 68 or so in the case of FIG. 7B. Also, the angle θ of the tip portion is set to around 90 degrees regarding the hyper lens portion L2b according to an embodiment. Note that Ro/Ri is set to 6.58 or so in the case of FIG. 7B.

As is apparent from comparison between FIGS. 7A and 7B, with regard to light intensity, it can be found that improvement of around 10 times or so is realized in comparison with the preceding example (pay attention to that the increments of intensity |E | are 10 times in FIG. 7A).

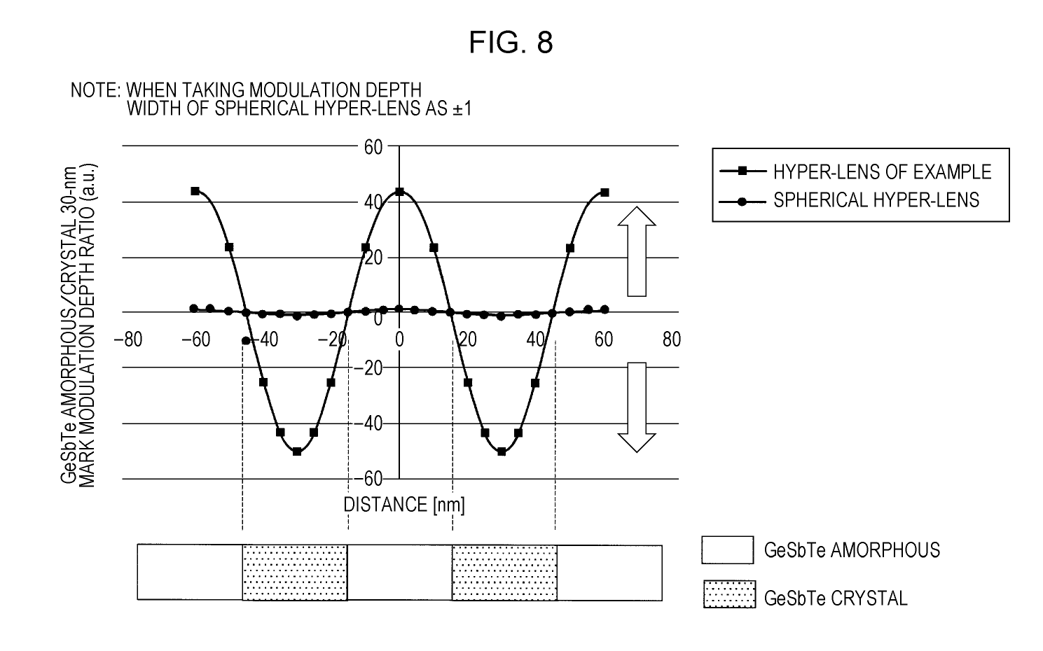

FIG. 8 is a diagram comparing modulation levels in the case of employing the hyper lens portion L2b according to an embodiment, and in the case of employing the hyper lens portion L2′b according to the preceding example.

Note that a condition set at the time of obtaining a simulation result illustrated in this drawing is the same as with the case of FIGS. 7A and 7B. Also, with the simulation, it was assumed that a crystal mark is formed on a recording film made up of GeSbTe amorphous. At this time, the mark length and space length were fixedly set to 30 nm.

The lateral axis represents distance (time), and the vertical axis represents a modulation level ratio at the time of a modulation width in the case of employing the hyper lens portion L2′b according to the preceding example is taken as ±1. The plotted dots represent a result of the case of employing the hyper lens portion L2′b according to the preceding example, and the plotted squares represent a result of the case of employing the hyper lens portion L2b according to an embodiment, respectively.

As is apparent with reference to FIG. 8, according to the hyper lens portion L2b according to an embodiment, significant improvement in a modulation level is realized as compared to the hyper lens portion L2′b according to the preceding example. Specifically, in this case, improvement in a modulation level of around fifty times or so is realized.

Here, with the hyper lens portion L2b according to an embodiment, the size of a light spot to be formed and light intensity thereof tend to principally depend on the angle θ of the tip portion on the incident side.

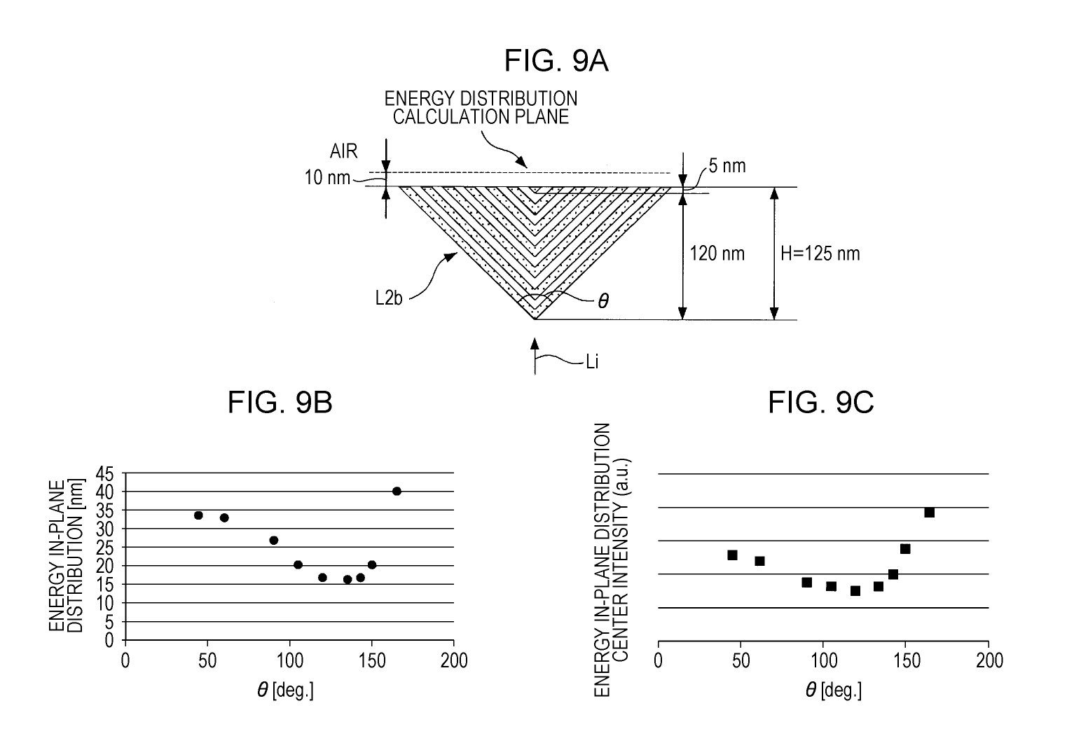

FIGS. 9A through 9C are diagrams for describing this point. FIG. 9B illustrates a simulation result regarding an energy in-plane distribution (full width at half maximum) as to the angle θ, i.e., relationship of the radius of a light spot, and FIG. 9C illustrates a simulation result regarding relationship of energy in-plane distribution center intensity as to the angle θ.

Now, conditions set at the time of obtaining the simulation results illustrated in FIGS. 9B and 9C will be described with reference to FIG. 9A. First, an energy distribution calculation surface is positioned 10 nm from the objective surface of the hyper lens portion L2b as illustrated in FIG. 9A.

Also, in this case, the film thicknesses of the first and second thin films making up the hyper lens portion L2b are each set to 10 nm, and these first film thickness and second film thickness are alternately repeatedly laminated six times (first thin film×6, second thin film×6). In this case, the objective surface of the hyper lens portion L2b is taken as a planar surface, and accordingly, the first thin film made up of a triangular cross-sectional shape as illustrated in FIG. 9A is formed in a position closest to the objective side (i.e., the seventh layer exists regarding the first thin film).

Thickness H of the hyper lens portion L2b in this case is 125 nm (six-time repeated laminated portions=120 nm, and the seventh layer of the first film=5 nm). Note that the first thin film is configured of Ag, and the second thin film is configured of Al₂O₃. Also, the wavelength λ and numeric aperture NA of incident light Li as to the hyper lens portion L2b are set to λ=375 nm and NA=1.61.

According to the result of FIG. 9B, it can be found that the spot size varies depending on the angle θ. Specifically, the spot size is the minimum around generally the angleθ=130 degrees, and light intensity tends to increase according to the angle θ increasing or decreasing therefrom.

Also, according to the result of FIG. 9C, it can be found that the center light intensity of a spot also varies depending on the angle θ. Specifically, the light intensity is the minimum around generally the angle θ=120 degrees, and the light intensity tends to increase according to the angle θ increasing or decreasing therefrom.

Here, with the present embodiment, the system using local near-field light is employed, and accordingly, the light intensity of the spot significantly great as compared to the preceding example. In this sense, it can be said that the spot size has principally to be set to a reference at the time of determining the angle θ.

In the light of this point, it can be said that it is desirable to set the angle θ within a range of generally 80 through 160 degrees in the sense of realizing the same spot size equal to or smaller than around 50 nm as with the preceding example (see FIG. 9B). Alternatively, in the case of realizing further reduction in the spot size, it is desirable to set the angle θ to within a range of generally 100 through 150 degrees.

Incidentally, at the time of actually determining the angle θ, occurrence of reflection and scattering generated at the hyper lens portion L2b has to be taken into consideration. This is because deterioration in SNR is caused by stray light due to these reflection and scattering.

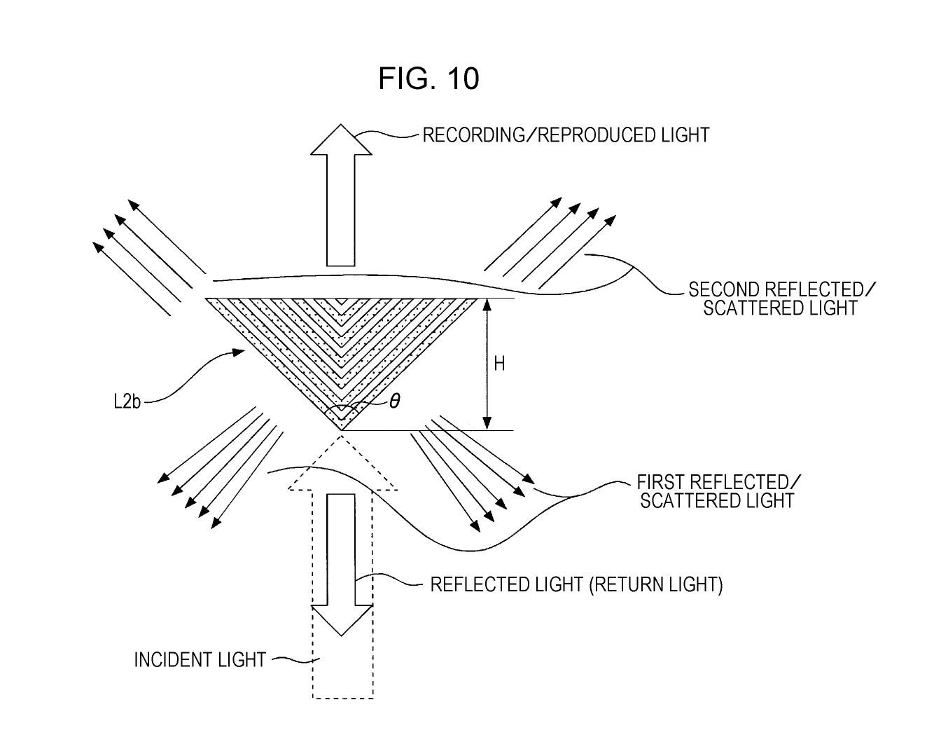

FIG. 10 is an explanatory diagram regarding stray light due to reflection and scattering to be caused at the hyper lens portion L2b. In the event that light has been input to the hyper lens portion L2b (dashed arrow in FIG. 10), recording/playing light indicated with a white arrow pointing in the upward direction in FIG. 10 is emitted by the hyper lens portion L2b due to the previously described local near-field effect or the like.

Also, the hyper lens portion L2b has light reversibility as described above, and accordingly, return light from an optical recording medium of playing light thus emitted is output via the hyper lens portion L2b at the time of playing (white arrow pointing in the downward direction in FIG. 10).

Along therewith, with the hyper lens portion L2b, there may be caused noise light to be emitted on the light incident side such as indicated as first reflected/scattered light in FIG. 10. Also, simultaneously, there may be caused noise light to be emitted on the optical recording medium side (objective side) such as indicated as second reflected/scattered light in FIG. 10.

The first reflected/scattered light emits in the film surface radiating direction of the first and second thin films. Also, the second reflected/scattered light emits in the film surface tangential direction of the first and second thin films.

With regard to the first reflected/scattered light, at least part thereof is guided to a light reception unit along with reflected light (return light) regarding playing light, and deteriorates the SNR. Also, after the second reflected/scattered light is reflected at the recording surface (reflection surface) of the optical recording medium, at least part thereof is guided to the light reception unit along with return light, and deteriorates the SNR.

Now, if we say that the angle θ is great, the amount of the first reflected/scattered light to be guided to the light reception unit along with return light (i.e., the generated amount of stray light) increases, and the SNR is further deteriorated, as a tendency. On the other hand, with regard to the second reflected/scattered light, the greater the angle θ is, the wider the angle for this light being emitted is, and accordingly, the amount of the reflected light from the optical recording medium to be returned to the light reception unit side along with return light (generated amount of stray light) decreases, and the SNR is improved, as a tendency.

If we say that the angle θ is small, relationship opposite of the above holds. Specifically, stray light due to the first reflected/scattered light decreases, deterioration in the SNR due to this stray light tends to be suppressed, stray light due to the second reflected/scattered light increases, deterioration in the SNR due to this stray light tends to increase.

The angle θ has to be suitably set principally in balance with the spot size (and light intensity in the case of being requested), taking influence of stray light due to reflected/scattered light generated at the hyper lens portion L2b in this way into consideration.

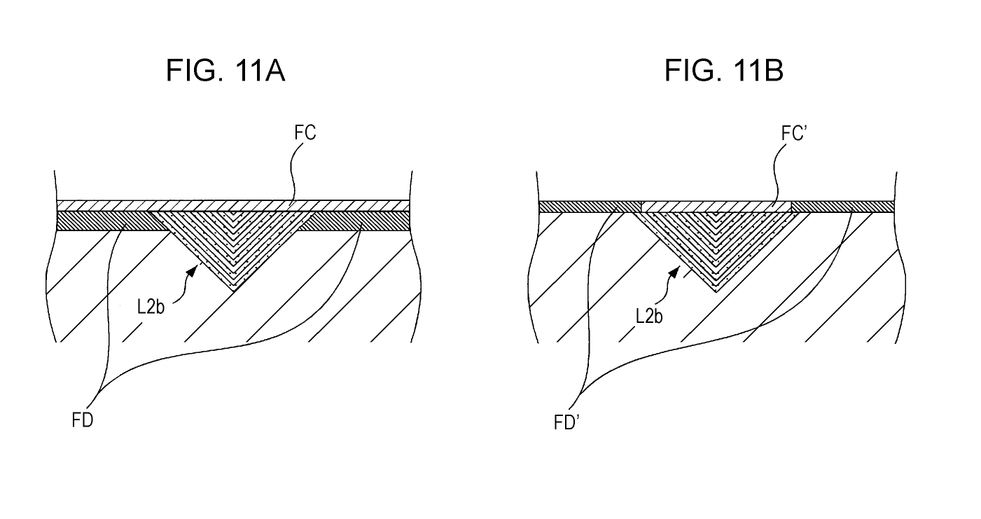

Here, with regard to stray light due to the second reflected/scattered light emitted on the objective side, suppression thereof can be realized by providing a mask layer as illustrated in FIGS. 11A and 11B on the objective surface side of the front lens L2, for example.

With the example illustrated in FIGS. 11A and 11B, a protection film is also provided together with a mask layer. Specifically, with the example in FIG. 11A, the whole of the objective surface of the hyper lens portion L2b is covered with a protection film FC. With the example of this drawing, the protection film FC is formed so as to cover a portion other than a portion where the hyper lens portion L2b is formed in the front lens L2.

Moreover, a mask layer FD is formed as to a region other than the region where the hyper lens portion L2b is formed, which is a region facing the objective surface of the front lens L2 (a region that is in contact with the protection film FC in this case). According to formation of such a mask layer FC, occurrence of stray light due to the second reflected/scattered light can effectively be suppressed. Also, according to formation of the protection film FC, reliability serving as the lens of the hyper lens portion L2b can be improved.

Also, FIG. 11B is an example wherein a mask layer and a protection film are formed in the same layer position. A protection film FC′ in this case is formed so as to cover only a partial region including the center portion instead of covering the whole of the objective surface of the hyper lens portion L2b in FIG. 11B. Moreover, the objective surface of the front lens L2, and a region not covered with the protection film FC′ in the objective surface of the hyper lens portion L2b are covered with a mask layer FD′.

According to this mask layer FD′, a portion of the hyper lens portion L2b is masked, whereby occurrence of stray light due to the second reflected/scattered light can effectively be suppressed. Note that with the example in FIG. 11B, a portion of the mask layer FD′ also serves as a protection film for protecting the hyper lens portion L2b.

According to formations of the mask layers illustrated in FIGS. 11A and 11B, occurrence of stray light due to the second reflected/scattered light can be suppressed, and accordingly, only the first reflected/scattered light is taken into consideration at the time of suppressing deterioration in the SNR due to stray light, i.e., it is desirable to set the angle θ as small as possible.

As described above, according to the objective lens OL according to the present embodiment, with regard to a laminated structure where a thin film of which the permittivity is negative, and a thin film of which the permittivity is positive are mutually laminated, a rectangular shape protruding on the incident side is given as the cross-sectional shape of each thin film, whereby light with high NA due to local near-field effect can be generated at this laminated structure, and propagated and irradiated on the optical recording medium (target object).

This is a technique taking advantage of light with high NA generated by local near-field effect, and accordingly, a spot size can be reduced as compared to the case of employing the near-field system using an SIL according to the related art in the same way as with the plasmon antenna system. That is to say, high recording density and large recording capacity can be realized.

Also, with the present embodiment, the laminated structure made up of a thin film of which the permittivity is negative, and a thin film of which the permittivity is positive is employed instead of a metal pin, whereby light reversibility can be obtained. That is to say, there can be omitted a complicated configuration such as employing different optical systems at the time of recording and at the time of playing. Also, in comparison with the preceding example, light intensity can be increased while equally reducing the spot size.

With the hyper lens portion L2b according to the present embodiment, an outer shape thereof is configured so as to be a pyramid shape or conical shape, and an entire cross-sectional shape thereof is configured so as to be a generally triangular shape. Thus, a component of NA>1 of light input to a foot portion of this triangle can be propagated and irradiated on an optical recording medium. That is to say, the use efficiency of light is improved accordingly.

### 3-2. First Manufacturing Method

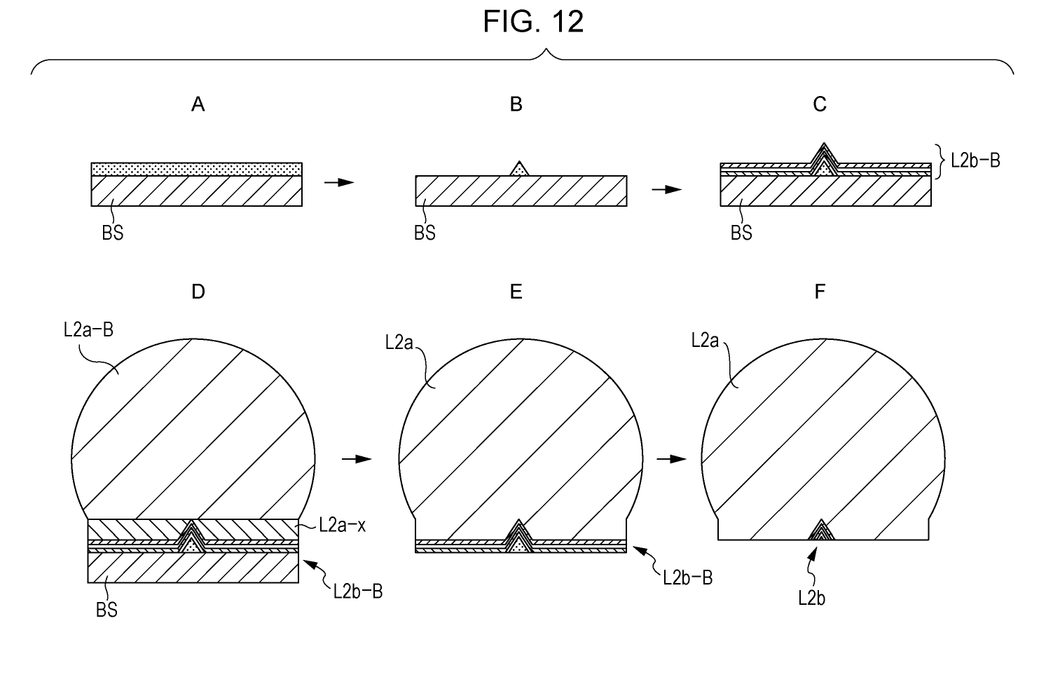

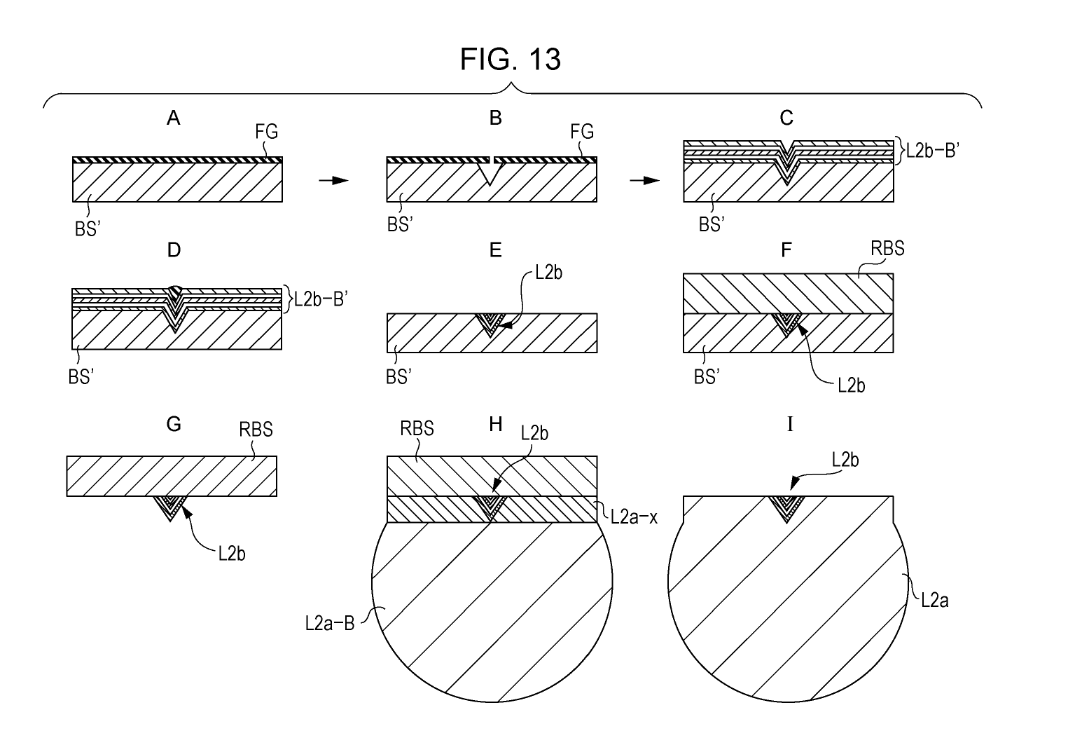

Next, description will be made regarding a manufacturing method of the front lens L2 included in the objective lens OL serving an embodiment described above. Hereafter, a first manufacturing method illustrated in FIG. 12, and a second manufacturing method illustrated in FIG. 13 will be described regarding a manufacturing method of the front lens L2.

First, the first manufacturing method will be described with reference to FIGS. 12A through 12C. The first manufacturing method is for forming a protruding portion of which the tip portion has a rectangular cross-sectional shape as to a substrate, and alternately laminating a first thin film and a second thin film as to this protruding portion, thereby forming the hyper lens portion L2b.

Specifically, first, with the first manufacturing method, as illustrated in FIG. 12A, a film made up of a formation material of either the first thin film or the second thin film is formed on a predetermined substrate BS. With the present example, the formation material of the first thin film will be formed.

Next, as a protruding portion formation process illustrated in FIG. 12B, a protruding portion of which the tip portion has a rectangular cross-sectional shape is formed, for example, by FIB working (FIB: Focused Ion Beam system, focused ion beam working viewing device), electron beam exposure, or the like.

Note that, with regard to a specific technique for forming such a protruding portion, a dot formation technique described in H. Toyota, et al., JJAP, 40 (2001) L747 may be employed, for example.

After forming a protruding portion, alternate laminating of the thin films forming the hyper lens portion L2b is performed as illustrated in FIG. 12C. Specifically, in this case, the protruding portion is formed with the first thin film material, and accordingly, alternate laminating from the second thin film to the first thin film is performed.

According to this laminating process, a laminated structure L2b-B of which the tip portion has a rectangular cross-sectional shape as illustrated in FIGS. 12A to 12F is formed. After the laminating processing in FIG. 12C is performed, a pasting process illustrated in FIG. 12D is performed.

Specifically, with this pasting process, a formation surface of the laminated structure L2b-B of the substrate BS attached with the laminated structure L2b-B formed in FIG. 12C is faced with the objective side planar surface of the SIL portion L2a-B serving as a super-semispherical SIL, and these are subjected to UV curing processing by filling a high-refractive-index resin L2a-x (e.g., the same refractive index as with the SIL portion L2a-B) between these.

According to this curing processing, the resin L2a-x is integrated with the SIL portion L2a-B. That is to say, as illustrated in FIG. 12E, the SIL portion L2a-B is integrated with the resin L2a-x, thereby forming the SIL portion L2a illustrated in the previous FIG. 5A.

After the pasting process in FIG. 12D, the substrate BS is peeled by a peeling process illustrated in FIG. 12E.

According to an etching process illustrated in FIG. 12F, a flat multilayer portion in the laminated structure L2b-B is removed by etching, for example, such as dry etching or the like. Thus, the front lens L2 configured of the SIL portion L2a and hyper lens portion L2b is generated.

### 3-3. Second Manufacturing Method

Next, the second manufacturing method will be described with reference to FIGS. 13A through 13F. The second manufacturing method is for forming a recessed portion of which the tip portion has a rectangular cross-sectional shape as to a substrate, and alternately laminating a first thin film and a second thin film on this recessed portion.

FIGS. 13A through 13F exemplify a case where formation of the recessed portion is performed by anisotropic etching. First, in this case, a guided film (mask material) FG is formed on a substrate BS′ that can be subjected to anisotropic etching by a formation process illustrated in FIG. 13A. Here, with anisotropic etching in this case, a recessed portion of which the tip portion has a rectangular cross-sectional shape, i.e., a recessed portion having a shape of which the width narrows as its position deepens is formed, and accordingly, a substrate having a property wherein etching speed in the horizontal direction is fast, and etching speed in the vertical direction is slow, is employed as the substrate BS′.

Examples of the material of the substrate BS′ include Si. Also, examples of the material of the guided film FG include SiN and SiO₂.

After the formation process in FIG. 13A, an etching process illustrated in FIG. 13B is performed. Specifically, after a hole is formed in the guided film FG by FIB, electron beam lithography, or the like, anisotropic etching using strong alkali solution is performed.

As described above, with the substrate BS′, etching speed in the horizontal direction is fast, and etching speed in the vertical direction is slow, and accordingly, a recessed portion having a triangular cross-sectional shape is formed in the substrate BS′ wherein the cross-sectional shape of the tip portion thereof becomes a rectangular shape as shown in FIGS. 13A to 131 in response to injection of the strong alkali solution.

After the recessed portion is formed by the etching processing in FIG. 13B, after the guided film FG is peeled, alternate laminating of the first thin film and second thin film is performed on a surface where the recessed portion on the substrate BS′ is formed, by a laminating process illustrated in FIG. 13C. Thus, the first thin film and second thin film are alternately laminated, and also, a laminated structure L2b-B′ having the rectangular protruding portion in the cross-section thereof is formed.

After the laminating process in FIG. 13C, as illustrated in FIG. 13D, a resist is patterned as to the rear side of the rectangular tip portion of the laminated structure L2b-B′ (becomes a triangular hole portion as illustrated in FIGS. 13A to 131).

Next, according to an etching process in FIG. 13E, a flat multilayer portion of the laminated structure L2b-B′ is removed by dry etching. Thus, the hyper lens portion L2b is formed within the recessed portion of the substrate BS′.

After the etching process in FIG. 13E, according to a pasting process in FIG. 13F, a substrate RBS for transcription is pasted on the surface of a side where the hyper lens portion L2b of the substrate BS′ is formed. Thus, the hyper lens portion L2b is in a state pasted on the substrate RBS for transcription.

After the pasting process in FIG. 13E, according to an etching process in FIG. 13G, the substrate BS′ is peeled by etching.

After the substrate BS′ is peeled in this way, according to a pasting process illustrated in FIG. 13H, the surface of a side where the hyper lens portion L2b of the substrate RBS for transcription is formed is faced with the objective side planar surface of the super-semispherical SIL portion L2a-B, and these are subjected to UV curing processing by filling a high-refractive-index resin L2a-x between these.

According to a peeling process illustrated in FIG. 131, the substrate RBS for transcription then is peeled. Thus, the front lens L2 configured of the SIL portion L2a and hyper lens portion L2b is formed.

### 3-4. Configuration of Optical Pickup

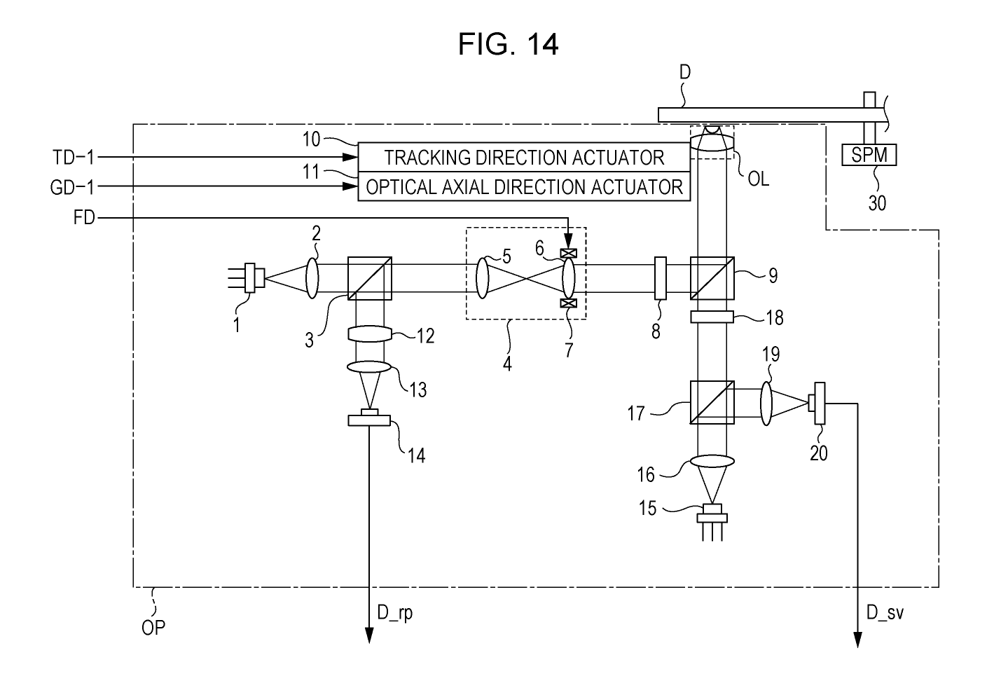

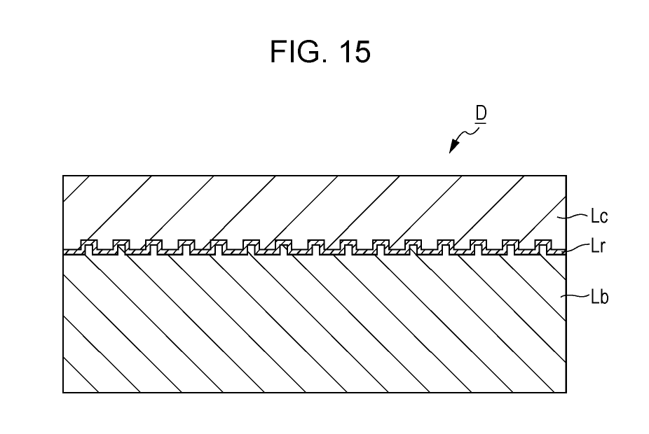

FIG. 14 is a diagram illustrating the internal configuration of principally an optical pickup (optical pickup OP) of an optical drive device serving as an embodiment configured of the objective lens OL.

First, in FIG. 14, an optical disc D which the optical drive device according to an embodiment takes as a recording/playing object is illustrated. The optical disc D is a disc-shaped optical recording medium wherein recording of information, and playing of recorded information are performed by irradiation of light.

FIG. 15 illustrates the cross-sectional configuration of the optical disc D. As illustrated in FIG. 15, with the optical disc D, a cover layer Lc, a recording layer Lr, and a substrate Lb are formed in this sequence. The emitted light from the objective lens OL included in the optical drive device is input from the cover layer Lc side.

The cover layer Lc is provided for protection of the recording layer Lr. The recording layer Lr is configured of a recording film where a recorded mark is formed according to irradiation of a laser beam by recording power, and a reflection film. In this case, the recording film is configured of a phase change material.

An uneven cross-sectional shape with formation of guide grooves as illustrated in FIG. 15 is provided to the recording layer Lr. Specifically, in this case, guide grooves are formed on the substrate Lb, and the recording layer Lr is formed as to a surface side where the guide grooves of this substrate Lb are formed, thereby providing an uneven cross-sectional shape to the recording layer Lr.

In the case of the present example, wobbling grooves are formed as the guide grooves, and recording is performed regarding absolute position information (radius position information or angle-of-rotation information) representing an absolute position on a disc using information of a meandering cycle of grooves. Here, the guide grooves are formed in a spiral shape (or may be a concentric shape).

Description will return to FIG. 14. In FIG. 14, the optical disc D is rotated by a spindle motor (SPM) 30. Light irradiation for recording of information, or for playing of recorded information using the optical pickup OP is performed on the optical disc D rotated by the spindle motor 30 in this way.

An optical system regarding the laser beam for recording/playing which is a laser beam for performing recording of information as to the recording layer Lr and playing of recorded information in the recording layer Lr, and an optical system regarding the laser beam for gap servo which is a laser beam for performing gap length servo for maintaining a gap G between the objective lens OL and the optical disc D are provided within the optical pickup OP.

As disclosed in Japanese Unexamined Patent Application Publication No. 2010-33688, as for the laser beam for recording/playing and the laser beam for gap servo, laser beams having a different wavelength band are employed. In the case of the present example, the wavelength of the laser beam for recording/playing is set to, for example, 405 nm or so, and the wavelength of the laser beam for gap servo is set to, for example, 650 nm or so.

First, with the optical system of the laser beam for recording/playing, the laser beam for recording/playing emitted from the laser 1 for recording/playing is converted into parallel light via the collimation lens 2, and is then input to the polarization beam splitter 3. The polarization beam splitter 3 is configured so as to transmit the laser beam for recording/playing thus input from the laser 1 for recording/playing side.

The laser beam for recording/playing which has transmitted the polarization beam splitter 3 is input to a focus mechanism 4 configured of a fixed lens 5, a moving lens 6, and a lens driving unit 7. This focus mechanism 4 is provided for adjusting a focus position of the laser beam for recording/playing.

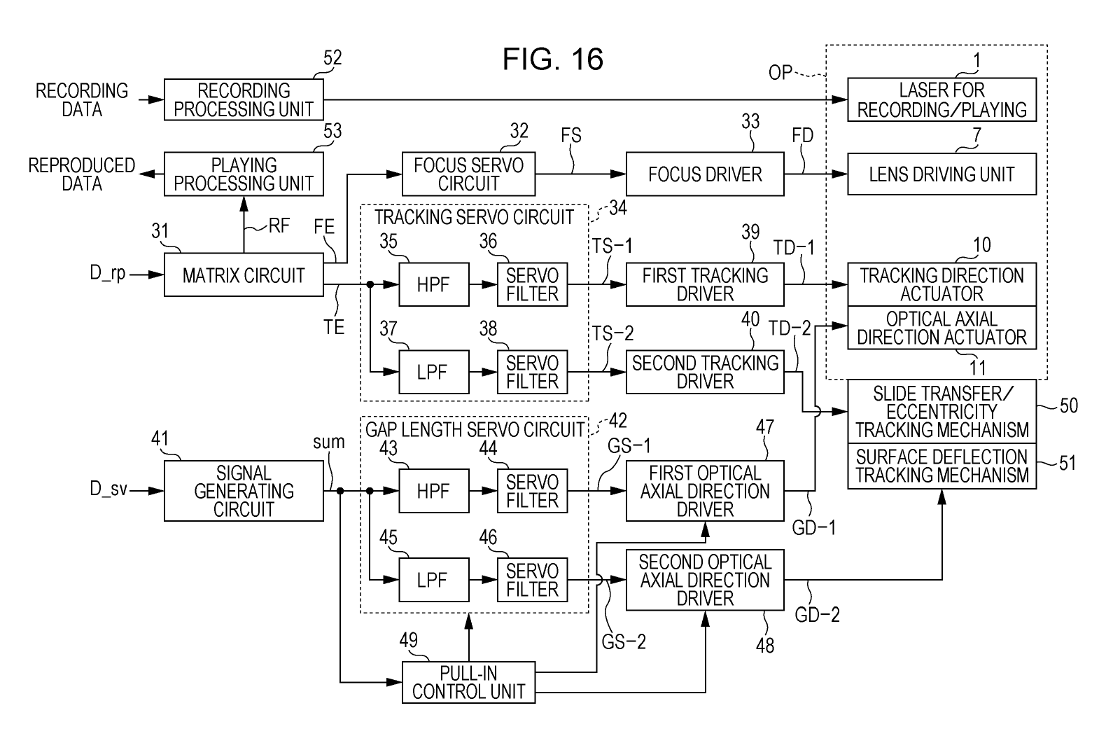

With the focus mechanism 4, the fixed lens 5 is disposed on a side closer to the laser 1 for recording/playing which is a light source, and the moving lens 6 is disposed on a side distant from the laser 1 for recording/playing. The lens driving unit 7 drives the moving lens 6 to a direction parallel to the optical axis of the laser beam for recording/playing. As also described later, the lens driving unit 7 is driven and controlled by a focus drive signal FD from a focus driver 33 illustrated in FIG. 16.

The laser beam for recording/playing passed through the fixed lens 5 and moving lens 6 in the focus mechanism 4 is input to the dichroic prism 9 via the quarter-wave plate 8. The dichroic prism 9 is configured such that the selective reflecting face thereof reflects light having the same wavelength band as with the laser beam for recording/playing, and transmits light having wavelengths other than that. Accordingly, the laser beam for recording/playing input as described above is reflected at the dichroic prism 9.

The laser beam for recording/playing reflected at the dichroic prism 9 is irradiated on the optical disc D via the objective lens OL as illustrated in FIG. 14.

Here, a tracking direction actuator 10 for displacing the objective lens OL in a tracking direction (the radius direction of the optical disc D), and an optical axial direction actuator 11 for displacing the objective lens OL in the optical axis direction (focus direction) are provided to the objective lens OL. In the case of the present example, piezoelectric actuators are employed as these tracking direction actuator 10 and optical axial direction actuator 11.

In this case, the objective lens OL is held at the tracking direction actuator 10, and the tracking direction actuator 10 which holds the objective lens OL in this way is held at the optical axial direction actuator 11. Thus, the objective lens OL can be displaced in the tracking direction and optical axial direction by driving these tracking direction actuator 10 and optical axial direction actuator 11.

Note that it goes without saying that even if an arrangement is made wherein, conversely, the optical axial direction actuator 11 holds the objective lens OL, and the optical axial direction actuator 11 is held at the tracking direction actuator 10, the same operation is obtained. The tracking direction actuator 10 is driven based on a first tracking drive signal TD-1 from a first tracking driver 39 illustrated in FIG. 16.

Also, the optical axial direction actuator 11 is driven based on a first optical axial direction drive signal GD-1 form a first optical axial direction driver 47 illustrated in FIG. 16.

At the time of playing, the reflected light from the recording layer Lr is obtained in response to the laser beam for recording/playing being irradiated on the optical disc D as described above. The reflected light of the laser beam for recording/playing thus obtained is guided to the dichroic prism 9 via the objective lens OL, and reflected at this dichroic prism 9.

The reflected light of the laser beam for recording/playing reflected at the dichroic prim 9 is passed through the quarter-wave plate 8 through the focus mechanism 4 (moving lens 6 to fixed lens 5), and is then input to the polarization beam splitter 3.

Here, the reflected light (return trip light) of the recording laser beam thus input to the polarization beam splitter 3 differs 90 degrees in a polarization direction thereof from the laser beam for recording/playing (outward trip light) input to the polarization beam splitter 3 from the laser 1 for recording/playing side, due to the effects of the quarter-wave plate 8 and the effects of reflecting at the recording layer Lr. As a result thereof, the reflected light of the laser beam for recording/playing input as described above is reflected at the polarization beam splitter 3.

The reflected light of the laser beam for recording/playing reflected at the polarization beam splitter 3 in this way is condensed on the light reception surface of a light reception unit 14 for recording/playing light via a cylindrical lens 12 through a condensing lens 13.

The light reception unit 14 for recording/playing light is configured of multiple light reception elements, and these light reception elements are disposed so as to generate a focus error signal, a tracking error signal (push pull signal), and an RF signal (playing signal) according to the astigmatic method.

Here, light reception signals according to the light reception elements included in the light reception unit 14 for recording/playing light will comprehensively be referred to as light reception signal D_rp.

Also, with the optical pickup OP illustrated in FIG. 14, a laser 15 for gap servo, a collimation lens 16, a polarization beam splitter 17, a quarter-wave plate 18, a condensing lens 19, and a light reception unit 20 for gap servo are provided to the optical system of the laser beam for gap servo.

The laser beam for gap servo emitted from the laser 15 for gap servo is converted into parallel light via the collimation lens 16, and is then input to the polarization beam splitter 17. The polarization beam splitter 17 is configured so as to transmit the laser beam for gap servo (outward trip light) thus input from the laser 15 for gap servo side.

The laser beam for gap servo which has transmitted the polarization beam splitter 17 is input to the dichroic prism 9 via the quarter-wave plate 18.

As described above, the dichroic prism 9 is configured so as to reflect light having the same wavelength band as with the laser for recording/playing, and so as to transmit light having wavelength other than that, and accordingly, the laser beam for gap servo transmits the dichroic prism 9, and is input to the objective lens OL.

Now, as also described later, in a state in which the gap length is too long (state in which no near-field coupling occurs, and light generated by the objective lens OL is not propagated to the optical disc D), the laser beam for gap servo is fully reflected at an edge surface of the objective lens OL (edge surface of the hyper lens portion L2b), and the amount of return light becomes the maximum. On the other hand, in a state in which the gap length is suitable (near-field coupled state), the amount of reflected light at the edge surface of the objective lens OL decreases by an equivalent amount, and the amount of return light also decreases.

Gap length servo is performed by taking advantage of fluctuation in the amount of light of reflected light of the laser beam for gap servo from the edge surface of the objective lens OL correlated with such gap length.

The reflected light (return trip light) of the laser beam for gap servo from the edge surface of the objective lens OL transmits the dichroic prism 9, and is then input to the polarization beam splitter 17 via the quarter-wave plate 18.

The reflected light of the laser beam for gap servo serving as return trip light thus input to the polarization beam splitter 17 differs 90 degrees in a polarization direction thereof form the outward trip light depending on the operation of the quarter-wave plate 18 and the operation at the time of reflection at the objective lens OL, and accordingly, the reflected light of the laser beam for gap servo serving as outward trip light is reflected at the polarization beam splitter 17.

The reflected light of the laser beam for gap servo reflected at the polarization beam splitter 17 is condensed on the light reception surface of the light reception unit 20 for gap servo via the condensing lens 19.

In the case of the present example, the light reception unit 20 for gap servo is configured of multiple light reception elements. Light reception signals according to the light reception elements included in the light reception unit 20 for gap servo will comprehensively be referred to as light reception signal D_sv.

### 3-5. Internal Configuration of Entire Drive Device

FIG. 16 illustrates the entire internal configuration of the optical drive device according to an embodiment. Note that, in FIG. 16, with regard to the internal configuration of the optical pickup OP, of the configuration illustrated in the previous FIG. 14, only the laser 1 for recording/playing, lens driving unit 7, tracking direction actuator 10, and optical axial direction actuator 11 are extracted and illustrated. Also, in FIG. 16, drawing of the spindle motor 30 is omitted.

First, a recording processing unit 52 is provided to the optical drive device. Data to be recorded (recorded data) in the optical disc D is input to the recording processing unit 52. The recording processing unit 52 subjects the input recorded data to, for example, addition of an error correction code or predetermined recorded modulation encoding or the like, thereby obtaining a recorded modulation data string which is a binary data string of “0” and “1” to be actually recorded in the optical disc D, for example.

The recording processing unit 52 generates a recording pulse signal according to the recorded modulation data string, and drives the laser 1 for recording/playing within the optical pickup OP for emission based on this recording pulse signal.

Also, a matrix circuit 31 and a playing processing unit 53 are provided to the optical drive device as a configuration for playing information recorded in the optical disc D. The matrix circuit 31 generates a signal to be used based on the light reception signal D_rp from the light reception unit 14 for recording/playing light illustrated in the previous FIG. 14.

Specifically, the matrix circuit 31 generates an RF signal (playing signal), a focus error signal FE, and a tracking error signal TE based on the light reception signals from the multiple light reception elements serving as the light reception signal D_rp. The matrix circuit 31 generates a sum signal as the RF signal, and generates the focus error signal FE using computation corresponding to the astigmatic method. Also, the matrix circuit 31 generates a push pull signal as the tracking error signal TE.

Note that a generation technique of the focus error signal FE and tracking error signal TE has not be restricted to the above, and another technique may also be employed. For example, the tracking error signal TE may also be generated by the DPP method (differential push pull method).

The RF signal generated by the matrix circuit 31 is supplied to the playing processing unit 34. The playing processing unit 34 performs playing processing for restoring the above recorded data, such as decoding of a recorded modulation code or error correction processing or the like regarding the RF signal to obtain played data played from the above recorded data.

Also, with the optical drive device, a focus servo circuit 32, a focus driver 33, a tracking servo circuit 34, a first tracking driver 39, a second tracking driver 40, and a slide transfer/eccentricity tracking mechanism 50 are provided for realizing focus servo regarding the laser beam for recording/playing, tracking servo, and the entire slide servo of the optical pickup OP.

First, the focus error signal FE generated by the matrix circuit 31 is input to the focus servo circuit 32. The focus servo circuit 32 subjects the focus error signal FE to servo computation (phase compensation or loop gain addition) to generate a focus servo signal FS.

The focus driver 33 generates a focus drive signal FD based on the focus servo signal FS input from the focus servo circuit 33, and drives the lens driving unit 7 within the optical pickup OP using this focus drive signal FD. Thus, the focus of the laser beam for recording/playing is controlled so as to agree with the recording layer Lr.

The slide transfer/eccentricity tracking mechanism 50 holds the entire optical pickup OP in the tracking direction so as to enable the optical pickup OP to be displaced. This slide transfer/eccentricity tracking mechanism 50 is configured of a power unit having faster responsivity than a motor having a thread mechanism provided to an optical disc system according to the related art, for example, such as CD or DVD or the like, and displaces the optical pickup OP not only for slide transfer at the time of seeking but also for suppression of lens shift caused along with disc eccentricity in a state in which tracking servo is on.

In the case of the present example, the slide transfer/eccentricity tracking mechanism 50 includes a linear motor, and is configured so as to provide driving force according to this linear motor to a mechanism portion for holding the optical pickup OP in the tracking direction so as to enable the optical pickup OP to be displaced.

Here, the optical drive device according to the present embodiment is configured to drive the entire optical pickup OP so as to also follow disc eccentricity as described above, which is for considering that a visual field range is relatively narrow at a system employing the objective lens OL including the hyper lens portion L2b such as the present embodiment as compared to a BD system or SIL system according to the related art.

The tracking error signal TE generated at the matrix circuit 31 is input to the tracking servo circuit 34. A first tracking servo signal generating system made up of a high-pass filter (HPF) 35 and a servo filter 36 in FIG. 16, and a second tracking servo signal generating system made up of a low-pass filter (LPF) 37 and a servo filter 38 are formed within the tracking servo circuit 34.

The first tracking servo signal generating system corresponds to the tracking direction actuator 10 side holding the objective lens OL, and the second tracking servo signal generating system corresponds to the slide transfer/eccentricity tracking mechanism 50 side holding the optical pickup OP.

The tracking error signal TE is input by branching to the high-pass filter 35 and low-pass filter 37 within the tracking servo circuit 34. The high-pass filter 35 extracts a component equal to or greater than a predetermined cutoff frequency of the tracking error signal TE, and outputs to the servo filter 36.

The servo filter 36 performs servo computation regarding the output signal of the high-pass filter 35 to generate a first tracking servo signal TS-1. Also, the low-pass filter 37 extracts a component equal to or smaller than a predetermined cutoff frequency of the tracking error signal TE, and outputs to the servo filter 38.

The servo filter 38 performs servo computation regarding the output signal of the low-pass filter 37 to generate a second tracking servo signal TS-2. The first tracking driver 39 drives the tracking direction actuator 10 using a first tracking drive signal TD-1 generated based on the first tracking servo signal TS-1. Also, the second tracking driver 40 drives the slide transfer/eccentricity tracking mechanism 50 using a second tracking drive signal TD-2 generated based on the second tacking servo signal TS-2.

Note that, though description according to FIG. 16 is omitted, the tracking servo circuit 34 is configured to turn off a tracking servo loop, for example, according to a target address being instructed for a control unit for performing entire control of the optical drive device, and to provide an instruction signal for track jump or seek movement to the first tracking driver 39 or second tracking driver 40.

Here, with the tracking servo circuit 34, the cutoff frequency of the low-pass filter 37 is set to a frequency equal to or higher than a disc eccentricity cycle (cycle of change of a positional relation between a light spot position and a track position in accordance with disc eccentricity). Thus, the slide transfer/eccentricity tracking mechanism 50 can drive the optical pickup OP so as to follow disc eccentricity.

That is to say, as a result thereof, the amount of lens shift of the objective lens OL due to disc eccentricity can significantly be suppressed, and the laser beam for recording/playing can be prevented from deviating from the visual field range (visual field entire width). In other words, occurrence of a situation can be prevented wherein the laser beam for recording/playing deviates from the visual field range due to disc eccentricity, and recording/playing is not performed.

Also, with the optical drive device, a signal generating circuit 41, a gap length servo circuit 42, a first optical axial direction driver 47, a second optical axial direction driver 48, a pull-in control unit 49, and a surface deflection tracking mechanism 51 are provided as a configuration for realizing gap length servo.

First, the surface deflection tracking mechanism 51 holds the slide transfer/eccentricity tracking mechanism 50 holding the optical pickup OP so as to enable the slide transfer/eccentricity tracking mechanism 50 to be displaced in the optical axial direction (focus direction).

In the case of the present example, this surface deflection tracking mechanism 51 is also configured of a linear motor, and is configured so as to have relatively high-speed responsivity. The surface deflection tracking mechanism 51 drives the slide transfer/eccentricity tracking mechanism 50 in the optical axial direction using the power of this linear motor, which causes the optical pickup OP to be displaced in the optical axial direction.

Note that, with regard to a positional relation between this surface deflection tracking mechanism 51 and the slide transfer/eccentricity tracking mechanism 50 as well, in the same way as with the previous relation between the tracking direction actuator 10 and the optical axial direction actuator 11, operation to be obtained is the same even if the relation of these are switched.

The signal generating circuit 41 generates a signal serving as an error signal at the time of gap length servo based on the light reception signal D_sv according to the light reception unit 20 for gap servo illustrated in FIG. 14 (light reception signals from the multiple light reception elements). Specifically, the signal generating circuit 41 generates a sum signal (entire light amount signal) sum.

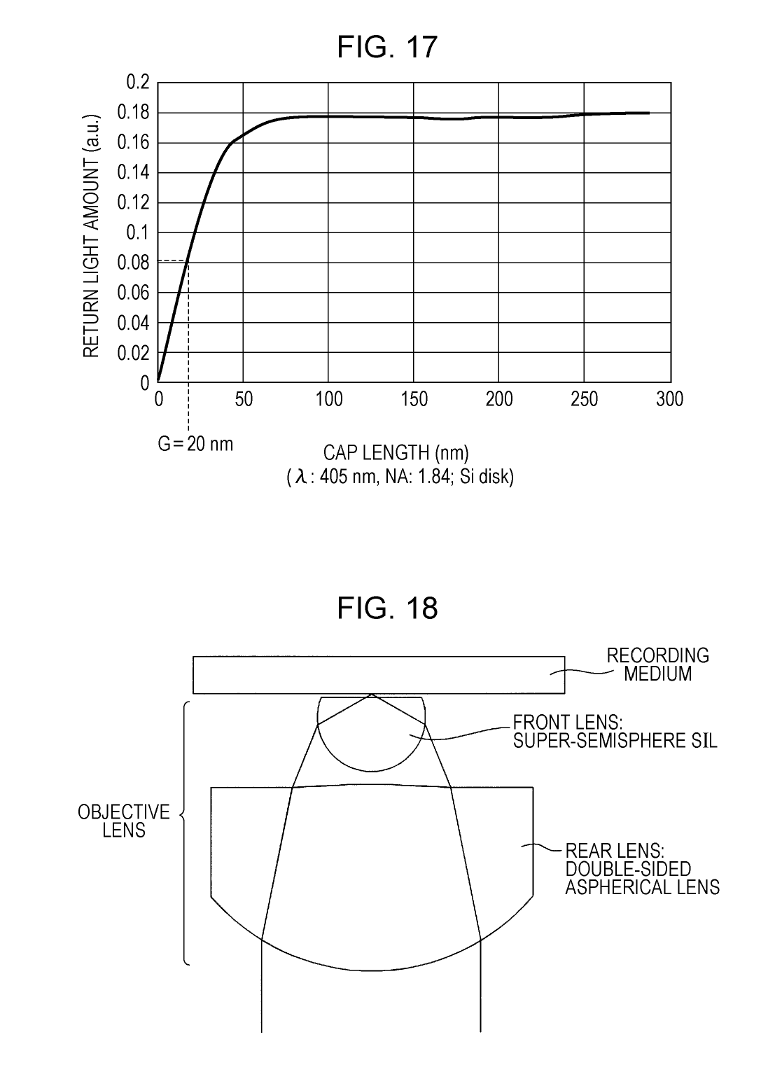

FIG. 17 is a diagram for describing a relation between the gap length and return light amount from the objective lens OL (return light amount form the objective side edge surface of the hyper lens portion L2b). Note that, though this FIG. 17 illustrates a relation between the gap length and the amount of return light in the case of employing a silicon (Si) disc as an example, generally the same relation is obtained in the case of employing the recording layer Lr made up of a phase change material such as the present example.

As illustrated in this FIG. 17, the amount of return light from the objective lens OL becomes the maximum value at a region where the gap length is too long, and near-field coupling does not occur.

On the other hand, at a region where the gap length is near 50 nm serving as a quarter of wavelength or shorter, the amount of return light gradually decreases as the gap length shortens according to operation of near-field coupling.

In the event of placing priority on operation according to near-field coupling, though shorter gap length is advantageous, collision and friction between the objective lens OL and the optical disc D cause a problem when shortening the gap length. Therefore, the gap length is set so as to leave a certain level of space as to the optical disc D within a range where near-field coupling occurs. Based on this point, with the present example, the gap length (gap G) is set to 20 nm or so.

In FIG. 17, the target value of the amount of return light in the case of the gap G=20 nm for example is around 0.08 or so. At the time of performing gap length servo, the target value regarding the amount of return light is obtained from the value of the gap G beforehand. Gap length servo is performed so that the amount of detected return light is fixed with the target value thus obtained beforehand.

Description will return to FIG. 16. The sum signal sum generated by the signal generating circuit 41 is input to the pull-in control unit 49 along with the gap length servo circuit 42.

With the gap length servo circuit 42, a first gap length servo signal generating system made up of a high-pass filter 43 and a servo filter 44, and a second gap length servo signal generating system made up of a low-pass filter 45 and a servo filter 46 are formed.

The first gap length servo signal generating system corresponds to the optical axial direction actuator 11, and the second gap length servo signal generating system corresponds to the surface deflection tracking mechanism 51.

The high-pass filter 43 inputs the sum signal sum, extracts a component of which the frequency is equal to or greater than a predetermined cutoff frequency of this sum signal sum, and outputs to the servo filter 44. The servo filter 44 performs servo computation regarding the output signal of the high-pass filter 43 to generate a first gap length servo signal GS-1.

Also, the low-pass filter 45 inputs the sum signal sum, extracts a component of which the frequency is equal to or smaller than a predetermined cutoff frequency of this sum signal sum, and outputs to the servo filter 46. The servo filter 46 performs servo computation regarding the output signal of the low-pass filter 46 to generate a second gap length servo signal GS-2.

The target value regarding the sum signal sum obtained beforehand based on the gap G (i.e., the value of the sum signal sum at the time of the gap G) is set to the gap length servo circuit 42, the servo filters 44 and 46 generate the gap length servo signals GS-1 and GS-2 for taking the value of the sum signal sum as this target value, respectively, by the above-described servo computation.

The first optical axial direction driver 47 drives the optical axial direction actuator 11 using the first optical axial direction drive signal GD-1 generated based on the first gap length servo signal GS-1. Also, the second optical axial direction driver 48 drives the surface deflection tracking mechanism 51 using the second optical axial direction drive signal GD-2 generated based on the second gap length servo signal GS-2.

Here, with the gap length servo circuit 42 described above, the cutoff frequency of the low-pass filter 45 is set to a frequency equal to or greater than the surface deflection frequency of the disc. Thus, the optical pickup OP can be displaced by the surface deflection tracking mechanism 51 so as to follow the surface deflection of the disc.

The entire optical pickup OP is driven so as to follow surface deflection in this way, whereby prevention of collision with the optical disc D of the objective lens OL can be realized.

The pull-in control unit 49 is provided to perform pull-in control of gap length servo. The target value regarding the sum signal sum obtained based on the gap G (the value of the sum signal sum at the time of the gap G) is set to this pull-in control unit 49 beforehand. The pull-in control unit 49 performs pull-in control of gap length servo as follows based on the target value of the sum signal sum thus set.

First, in a state in which gap length servo is off, the pull-in control unit 49 computes difference between the value of the sum signal sum input from the signal generating circuit 41 and the above target value. The pull-in control unit 49 then determines whether or not the value of this difference is a value within a pull-in range set beforehand, and in the event that the value of the difference is not included in the pull-in range, generates a waveform for pull-in according to the above difference (signal for changing the sum signal sum in a direction where the difference decreases), and provides this to the first optical axial direction driver 47 and second optical axial direction driver 48. Thus, control can be performed so as to include the value of the sum signal sum in the pull-in range.

In the event of having determined that the value of the difference enters within the pull-in range, the pull-in control unit 49 causes the gap length servo circuit 42 to turn on the servo loop (both of the first and second gap length servo signal generating systems). Thus, the pull-in control is completed.

According to the optical drive device thus described, high density recording can be performed on the optical disc D using the objective lens OL, and large recording capacity of the optical disc D can be realized. Also, simultaneously, playing of information recorded with high recording density using the objective lens OL can be performed.

### 4. Modifications

Though description has been made so far regarding the embodiments of the present application, the present application does not have to be restricted to the specific examples described above. For example, with the above description, a case employing a solid immersion lens having a super-semispherical shape, as the SIL portion L2a, has been exemplified, but a solid immersion lens having a hemispherical shape may be employed.

Also, with the above description, a case has been exemplified wherein the outer shape of the hyper lens portion L2b is formed with a pyramid shape or conical shape, but the outer shape does not have to be restricted to these shapes in that more reduction in the spot size than the near-field method employing an SIL according to the related art is realized and also light reversibility is realized, and the hyper lens portion L2b has to have at least the region R1 illustrated in FIG. 6A. In this sense, the hyper lens portion L2b may also have a pin-shaped outer shape. However, the hyper lens portion L2b has to have a rectangular shape protruding on the incident side as a cross-sectional shape thereof (for obtaining local near-field effect).

Also, with the above description, though a case has been exemplified wherein the laminated structure (hyper lens) between the first and second thin films according to the present application is formed integral with a super-semispherical (or hemispherical) SIL as the hyper lens portion L2b, the laminated structure may also be formed separately from the SIL.

In the event that the hyper lens portion L2′b according to the preceding example has been formed separately from an SIL as described in the previous FIG. 3, the intensity of light irradiated on an optical recording medium is dramatically decreased by surface reflection thereof, but with the hyper lens portion L2b according to the present embodiment, unlike the case of the preceding example, a spot is formed by taking advantage of local near-field effect, and accordingly, influence due to surface reflection can dramatically be reduced as compared to the preceding example. Accordingly, the hyper lens portion L2b according to the present embodiment may be configured separately from an SIL.

Further, according to the laminated structure according to the present application, the front lens does not have to be formed integral with an SIL. This is because light with high NA is generated by local near-field effect, and accordingly, light to be input to this laminated structure does not have to be NA>1.

Also, with the above description, though only a case has been exemplified wherein with regard to the laminated structure according to the present application, the shape of the objective surface thereof is a plane, the shape of this objective surface is not restricted to a plane, and another shape may be employed, for example, such as a protruding shape or recessed shape having an appropriate curvature.

Also, with the above description, though a case has been exemplified wherein the optical recording medium to be recorded/played has a recording layer made up of a phase change material, the present application may also suitably be applied to in the case of employing an optical recording medium having a recording layer made up of a material other than a phase change material.

Also, the present application may also suitably be applied to the case of employing an optical recording medium made up of a so-called bit pattern medium, for example, such as disclosed in Japanese Unexamined Patent Application Publication No. 2006-73087.

Also, with the above description, though a case has been exemplified wherein the objective lens according to the present application is applied to an objective lens included in a system for performing recording/playing regarding an optical recording medium, the objective lens according to the present application may also suitably be applied to an application other than a recording/playing system of optical recording media, for example, such as an objective lens in a light microscope.

Also, the present application may also have configurations indicated in the following (1) through (12).
(1) An objective lens including, as a front lens disposed on the most objective side,

a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof.
(2) The objective lens according to (1), wherein the laminated structure is configured so as to have a generally triangular shape as a cross-sectional shape thereof.
(3) The objective lens according to (1) or (2), wherein a mask layer for reducing stray light due to reflection/scattering caused on the laminated structure, is formed on a region facing the objective surface of the front lens.
(4) The objective lens according to (1) through (3), wherein the first thin film is configured of one of Ag, Cu, Au, and Al.
(5) The objective lens according to (1) through (4), wherein the second thin film is configured of one of a silicon system compound, fluoride, nitride, metal oxide (Metal Oxide), glass, and polymer.
(6) The objective lens according to (1) through (5), wherein the first thin film is configured of Ag, and the second thin film is configured of Al2O3.
(7) The objective lens according to (1) through (6), wherein the laminated structure is configured so as to have a generally pyramid shape as an outer shape thereof
(8) The objective lens according to (1) through (6), wherein the laminated structure is configured so as to have a generally conical shape as an outer shape thereof
(9) The objective lens according to (1) through (8), wherein the objective surface of the laminated structure is covered with a protection film.
(10) The objective lens according to (1) through (9), wherein the front lens is configured so as to integrally form the laminated structure on the objective surface side of a solid immersion lens.
(11) The objective lens according to (1) through (10) configured so as to input light condensed by a solid immersion lens to the front lens configured to have the laminated structure.
(12) The objective lens according to (1) through (11), wherein an angle of a peak on a side to which light from the light source in the laminated structure input is generally 80 degrees to generally 160 degrees.

Note that the optical drive device according to the present application may be configured of an objective lens according to any of (1) through (12).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An objective lens comprising, as a front lens disposed on the most objective side,
a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof.

2. The objective lens according to claim 1, wherein said laminated structure is configured so as to have a generally triangular shape as a cross-sectional shape thereof

3. The objective lens according to claim 1, wherein a mask layer for reducing stray light due to reflection/scattering caused on said laminated structure, is formed on a region facing the objective surface of said front lens.

4. The objective lens according to claim 1, wherein said first thin film is configured of one of Ag, Cu, Au, and Al.

5. The objective lens according to claim 1, wherein said second thin film is configured of one of a silicon system compound, fluoride, nitride, metal oxide (Metal Oxide), glass, and polymer.

6. The objective lens according to claim 1, wherein said first thin film is configured of Ag, and said second thin film is configured of Al₂O₃.

7. The objective lens according to claim 2, wherein said laminated structure is configured so as to have a generally pyramid shape as an outer shape thereof

8. The objective lens according to claim 2, wherein said laminated structure is configured so as to have a generally conical shape as an outer shape thereof.

9. The objective lens according to claim 1, wherein the objective surface of said laminated structure is covered with a protection film.

10. The objective lens according to claim 1, wherein said front lens is configured so as to integrally form said laminated structure on the objective surface side of a solid immersion lens.

11. The objective lens according to claim 1 configured so as to input light condensed by a solid immersion lens to said front lens configured to have said laminated structure.

12. The objective lens according to claim 1, wherein an angle of a peak on a side to which light from said light source in said laminated structure input is generally 80 degrees to generally 160 degrees.

13. A lens manufacturing method for manufacturing a lens configured to have a laminated structure where a first thin film of which the permittivity is negative, and a second thin film of which the permittivity is positive are mutually laminated, and also the films are formed so as to have a rectangular shape protruding on a side to which light from a light source is input, as a cross-sectional shape thereof, comprising:
a protruding portion forming process arranged to form a protruding portion where the cross-sectional shape of a tip portion thereof is a rectangular shape as to a substrate; and
a laminating process arranged to mutually laminate said first thin film and said second thin film as to said protruding portion formed in said protruding portion forming process.

14. A lens manufacturing method for manufacturing a lens configured to have a laminated structure where a first thin film of which the permittivity is negative, and a second thin film of which the permittivity is positive are mutually laminated, and also the films are formed so as to have a rectangular shape protruding on a side to which light from a light source is input, as a cross-sectional shape thereof, comprising:
a recessed portion forming process arranged to form a recessed portion where the cross-sectional shape of a tip portion thereof is a rectangular shape as to a substrate; and
a laminating process arranged to mutually laminate said first thin film and said second thin film as to said recessed portion formed in said recessed portion forming process.

15. An optical drive device comprising:
an objective lens including as a front lens disposed in a position closest to an optical recording medium
a front lens configured to have a laminated structure wherein a first thin film of which the permittivity is negative, and a second thin film of which the permittivity is positive are mutually laminated, and also the films are formed so as to have a rectangular shape protruding on a side to which light from a light source is input, as a cross-sectional shape thereof; and
a recording/playing unit configured to perform recording of information as to said optical recording medium or playing of recorded information of said optical recording medium by performing light irradiation as to said optical recording medium via said objective lens.
